(19) United States
(12) Patent Application Publication
(10) Pub. No.: US 2015/0095090 A1
(43) Pub. Date: Apr. 2, 2015

(54) SYSTEMS, DEVICES, AND METHODS FOR LANDSCAPE MANAGEMENT WITH PREDICTIVE IRRIGATION SYSTEM ADJUSTMENT INDEX CALCULATION CAPABILITY

(71) Applicant: Cognetive Systems Incorporated, Irvine, CA (US)

(72) Inventors: Greig E. Altieri, Laguna Beach, CA (US); Matthew K. Davenport, Ladera Ranch, CA (US); Howard J. Jelinek, Laguna Beach, CA (US); Jae Y. Kim, Irvine, CA (US); Henry M. Ortiz, Aliso Viejo, CA (US)

(21) Appl. No.: 14/491,869

(22) Filed: Sep. 19, 2014

Related U.S. Application Data
(60) Provisional application No. 61/960,940, filed on Oct. 1, 2013.

(51) Int. Cl. G06Q 10/06; A01G 25/16

(52) U.S. Cl. CPC G06Q 10/06313; A01G 25/16
USPC 705/7.23

(57) ABSTRACT

A system for landscape management includes an irrigation billing cycle budget calculation engine with predictive irrigation system adjustment index calculation capability such that the cost of irrigation water as well as volume of irrigation water may be managed, and such that weather-based guidance for the corrective actions to the irrigation system is automatically provided by the system.

### CROSS-REFERENCE TO RELATED APPLICATIONS

The present patent application is related to and claims benefit under 35 U.S.C. §119(e) from U.S. Provisional Patent Application Ser. No. 61/960,940, filed Oct. 1, 2013, the entire contents of which being incorporated herein by reference in its entirety.

### FIELD

The present disclosure is in the technical field of landscape management which may be applied to landscape irrigation management. More particularly, the present disclosure is in the technical field of weather-based irrigation management such that systems, devices, and methods which utilize historical and current weather data, irrigated landscape information, and the irrigation water retailer's water billing cycle, water budget calculation and water rate structure in order to determine whether or not the actual volume of water used in irrigating a particular landscape is within the water retailer's water budget in terms of water volume and water cost, and also computes and provides a predictive irrigation system adjustment factor that is used as a guide in adjusting the landscape's irrigation system such that irrigation water volumes and costs may be better managed.

### BACKGROUND

Conventional tools for computing weather-based landscape irrigation budgets are well known within the professional landscaping and irrigation industries, and as such it is not uncommon to find simple spreadsheets and application software which, when supplied with the prerequisite input variables and constants, may be used for computing a weather-based irrigation budget for any given project or landscape according to the project or landscape plant material's irrigation needs and for any given period of time. A weather-based irrigation budget is dependent on several factors including the area of the landscape, and the types and areas of the different plant materials which cover the landscape for which the budget is representative. Historically, weather-based irrigation budgets have been used to determine the irrigation water needs of crops and landscape plant materials over time such that crops and plant materials remain healthy as weather changes over time. Irrigation budgets may be calculated for any size or area of landscape and thus may be computed and used to determine the irrigation needs of plant materials covering relatively small, residential landscapes which may occupy only hundreds of square feet, or even large community and commercial landscapes which may occupy several acres. With respect to volumes of water and thus water cost, typically, the larger the landscape, the larger the plant material irrigation requirement, and thus the larger the weather-based irrigation budget. Further, the larger the irrigation budget, the larger the volume of water and water cost which may be saved or wasted according to the irrigation budget.

While the scientific community has put forth many different equations for computing a weather-based irrigation budget with each incorporating varying degrees of sophistication, most equation variations have the same general format and include, at a minimum, the same basic input variables and constants. Following is an example of a general, weather-based irrigation budget equation which may be used for determining a given landscape area's weather-based plant material irrigation requirements, or irrigation budget for water which is delivered exclusively for satisfying landscape plant material irrigation needs:

Irrigation Budget=ETo*ETAF*LA

Where: ETo (Reference Evapotranspiration)=the amount of water which evaporates naturally from a given landscape plus the amount of water which would naturally transpire through a hypothetical turf reference crop standard if the given landscape were completely covered with the turf reference crop, for example. ETo is highly dependent on the local weather, geographical location, and time of year. ETAF=the ET Adjustment Factor which varies according to the landscape's true irrigated plant materials, geographic location and time of year. LA=Landscape Area to be irrigated. It should be appreciated that, in application and with respect to landscape irrigation and particularly large landscapes, LA, or the Landscape Area referred to in the general weather-based irrigation budget equation above is typically applied as the landscape area served by an individual metered, water delivery point within a landscape, and because there may be many individual metered water delivery points within an individual landscape, it is common to treat irrigation budgets on an individual meter by meter basis and according to the landscape area served by each individual meter. Thus, with regard to large landscapes and irrigation budgets, Landscape Area is the landscape area which is served by an individual water meter present within the landscape and the water meter's water delivery system. The treating of irrigation budgets on a meter by meter basis also coincides with the fact that typically, water suppliers also treat and therefore bill for each water meter separately, even when a single landscape has multiple water meters. It should be further appreciated that water which is delivered for mixed uses, i.e. residential use wherein water resources are consumed for both outdoor uses such as landscape irrigation, as well as indoor uses such as bathing and cooking, may also be evaluated using budgeting techniques, however, the equations used for determining mixed use budgets require additional input variables and constants to account for in-home, non-irrigation related water consumption.

Thus, it can be seen that the basic input variables of ETo, ETAF, and input constant of LA are required to compute a basic weather-based irrigation budget for a particular landscape's plant material irrigation requirements. The input variable of ETo is the most dynamic input variable in the irrigation budget equation, and even though ETo changes constantly, the smallest period of time over which ETo is typically computed is a 24 hour period, and thus ETo data for any particular area or region is typically made available each calendar day and is representative of the previous day's ETo for that particular area or region for which ETo has been computed. Thus, the most frequently that a weather-based irrigation budget is typically able to be calculated is daily and is representative of the previous day's irrigation budget for the particular landscape for which the irrigation budget has been computed. Thus weather-based irrigation budgets are backward looking and not forward looking Typically, an irrigator is able to learn today what his or her weather-based irrigation budget was for the previous day, however, because tomorrow's ETo cannot be known for certain, an irrigator cannot know for certain the weather-based irrigation budget for tomorrow.

Despite the backward looking nature of weather-based irrigation budgets, the regular, weather dependent behavior of ETo is well understood by both the scientific community and the professional landscaping and irrigation industries, and allows for weather-based irrigation budgets to be used as an irrigation management tool. In effect, weather-based irrigation budgets allow irrigators to assess whether or not sufficient, insufficient or excessive amounts of water are being delivered in order to satisfy a given landscape's plant material irrigation requirements over time.

As previously described, typically, the larger the landscape, the larger the volume of water and water cost which may be saved or wasted according to the landscape's weather-based irrigation budget. Further, in practice, large landscapes such as are found on commercial properties, residential community common areas, parks, etc., are most often maintained and irrigated by professional landscaping companies, or professional irrigation management companies. It should also be appreciated that it is more and more common for the professional landscaping company, and thus the landscaping company's irrigators, who maintain the landscape to increasingly be held accountable for landscape irrigation costs in addition to simply landscape maintenance and appearance. It follows then that when assessing the effectiveness of weather-based irrigation budgets as a way for determining a landscape's plant material's irrigation requirements, as well as how the implementation and use of weather-based irrigation budgets as irrigation management tools may be improved, professional landscaping companies and their irrigators who employ weather-based irrigation budget management practices are of particular interest.

As previously described, the most frequently that weather-based irrigation budgets are typically able to be computed is on a daily basis, and as such will represent the previous day's irrigation budget. Therefore, the most frequently that an irrigator is typically able to utilize a weather-based irrigation budget to assess the volume of water used to irrigate a particular landscape according to the landscape's plant material irrigation needs is daily and would require daily examination of the landscape's previous day's irrigation budget together with the landscape's previous day's actual irrigation usage. Therefore and in theory, daily assessment of actual irrigation water consumption compared to the weather-based irrigation budget would allow the irrigator to adjust the landscape's irrigation delivery system for the present day based on yesterday's experience in an attempt to remain at or below the landscape's irrigation budget over time. In practice, however, daily assessment of actual irrigation usage, the weather-based irrigation budget, and according irrigation delivery system corrective adjustments are seldom practical for economic reasons. Irrigators, and especially those employed by professional landscaping companies, simply have neither the funds nor the staff to make daily irrigation assessments and corrective adjustments to the large numbers of irrigation systems deployed across each of the many landscapes for which they are typically responsible. Instead, an examination of landscaping and irrigation industry current practices with regard to utilization of weather-based irrigation budgets as a management tool demonstrates that typically, the most frequent that irrigation assessments and irrigation system adjustments are made is on a weekly basis, and sometimes even as infrequently as on a monthly basis. As a result of the typically periodic irrigation usage assessments, many days can pass during which the volume of water which has passed through a meter goes unchecked and uncontrolled against the water meter's weather-based irrigation budget.

In practice, weekly irrigation water usage assessments and irrigation system adjustments are performed in the following manner. Irrigators visit each landscape where weather-based irrigation budgeting is implemented for irrigation management. While physically on site, meter readings are manually collected and recorded from each water meter within the irrigation budget managed landscape by any number of irrigators necessary to do so. The current meter read data is then returned to the office where it is consolidated with meter read data from each of the potentially many other landscapes under weather-based irrigation management. Current landscape water meter readings are compared to the previous week's meter readings so that the actual volume of water consumed during the previous week at each weather-based irrigation budget managed landscape meter may be determined. Additionally, daily ETo data for each weather-based irrigation budget managed landscape meter is collected from public or private sources as may be required by the relevant weather-based irrigation budget calculation, and is summed so that the previous week's ETo for each irrigation budget managed landscape meter is determined and may be used to compute each landscape water meter's irrigation budget for the entire previous week and according to each meter's relevant weather-based irrigation budget calculation. With the previous week's weather-based irrigation budgets and the previous week's actual water consumption data from each irrigation budget managed meter now available, the previous week's actual water consumption as compared to the previous week's irrigation budget may now be assessed on an individual meter by meter basis. Further, the irrigator is then able to determine which meters are over budget and should thus have their irrigation systems adjusted downward in an attempt to remain at or below the landscape meter's weather-based irrigation budget over time. As a simple but straightforward example of how irrigators attempt to remain at or below irrigation budget over time, a situation may occur where an irrigator determines that for a particular landscape meter, the irrigation water that was consumed during the previous week was 20% over the previous week's weather-based irrigation budget. To correct this excess in irrigation and in an attempt to remain at or below the meter's weather-based irrigation budget over time, the irrigator may choose to reduce the volume of water being delivered by the meter's irrigation system by 20% for the current week. If the irrigator chooses this as a corrective action, the irrigator intends for the total amount of irrigation water consumed at the particular meter to be at or below the irrigation budget over the past and present week together, a two week period. Alternatively, the irrigator may choose to correct the same 20% over budget situation by reducing the volume of water being delivered by the meter's irrigation system by 5%. If the irrigator chooses this latter corrective action option, then the irrigator intends for the total amount of irrigation water consumed to be at or below the meter's irrigation budget over the past week and the next four weeks together, a five week period. In this way, irrigators may attempt to correct past irrigation excesses by adjusting the irrigation delivery system downward such that it will deliver a future deficit in irrigation that will be equal to or greater than the past irrigation excess over time.

Again, and in practice, while the irrigation budget management process described above relies upon physical data and adheres to a logical protocol, the effectiveness of this management process is compromised by several factors. First and foremost, while water usage by volume is directly addressed, assessed and managed in current irrigation budget management processes which utilize weekly water meter reading to determine weekly water usage, the cumulative weekly cost of irrigation water is typically ignored. While some irrigation management practices may include the review of water bills to understand past monthly or bi-monthly water costs, this approach is inadequate as a management practice because it does not offer an opportunity to manage or control water costs during and throughout the billing cycle, and before excess water costs have already been incurred. Further, and on a water district by water district basis across the US, the implementation of tiered water rate structures is making weekly cumulative water cost extremely difficult to infer based on weekly cumulative water consumption alone. The reason for this is that within a tiered rate structure there is no uniform volumetric water rate, i.e. water volume consumed, and water cost are not linearly related.

In recent years, and in an effort to motivate water conservation, water districts throughout the US have begun adopting tiered water rate structures which financially reward irrigators for consuming a volume of landscape irrigation water which is less than or equal to a water volume threshold which has been established by the individual water district, and likewise financially penalizes irrigators for consuming a volume of landscape irrigation water which exceeds the established water volume threshold. Tiers within tiered rate water structures are typically bound by arbitrary volume thresholds which are established by each individual water district. The most simple tiered rate structures may have only two tiers, while more complex tiered rate structures may have several tiers with an escalation in water price at each successive tier threshold. Increasingly, water districts which adopt tiered rate structures are also incorporating a water budget, which is a form of weather-based irrigation budget, in order to include a landscape plant material irrigation needs component into their tiered rate structures. The effect of this policy is that the arbitrary water volume tier thresholds become based on a reference volume of water which is variable and tied to the weather and a landscape plant material need which has been deemed appropriate and adequate by the water district. The following example is presented in order to provide a better understanding of how budget based tiered rate structures function, as well as their implications. Currently, the Irvine Ranch Water District in Irvine, Calif., utilizes the following five tier structure for landscape irrigation customers where potable water is supplied: Tier 1 (Low Volume)=Usage of 0-40% of Water Budget=Cost of $0.88/Hundred Cubic Feet of Water Used; Tier 2 (Base Rate)=Usage of 41-100% of Water Budget=Cost of $1.34/Hundred Cubic Feet of Water Used; Tier 3 (Inefficient)=Usage of 101-110% of Water Budget=Cost of $3.91/Hundred Cubic Feet of Water Used; Tier 4 (Excessive)=Usage of 111-120% of Water Budget=Cost of $6.22/Hundred Cubic Feet of Water Used; Tier 5 (Wasteful)=Usage of 121%+of Water Budget=Cost of $12.60/Hundred Cubic Feet of Water Used. Additionally, the Irvine Ranch Water District employs the following equation, i.e. water budget rules, or budget rules, for determining the budget values which are incorporated into their tiered price structure as cited above, and because of the LA term, are unique to each landscape within their service area: Budget=ETo* Kc*LA*IE, where ETo is reference evapotranspiration, Kc is the warm season turf Crop Coefficient and varies throughout the year between approximately 0.50 and 0.80, LA is the Landscape Area served by an individual meter, and IE, is the meter's irrigation system's Irrigation system Efficiency factor of (1/71%). It should be pointed out that in the example above and as is common in tiered water rate structures, the price for water increases at each successive tier, and that the water price increase between the lowest and highest tiers is approximately 14.3 times.

Returning now to the increasing prevalence within the US of tiered water rate structures which are water budget based, or budget based, it should be appreciated that the budget component of the tiered rate structure is essentially an irrigation budget, and that the irrigation budget which has now become present in a water district's rate structure is in effect imposing a standard landscape irrigation water needs factor to which, at least for billing purposes, all other landscapes within the water district's service area will be not only compared, but judged. Importantly, and within this context, the role of the irrigation budget, which has historically been to determine the irrigation water needs of landscape plant materials whatever they may be, is shifting toward being used instead as an irrigation water standard to which landscape plant material needs must comply, a critical distinction.

Clearly, water pricing is becoming increasingly more complex and difficult to understand, even as water is becoming increasingly more expensive. One consequence of this is that current weather-based irrigation management practices are not equipped to track and control water costs, especially within budget based tiered rate structures where water costs are not linearly related to the water volume consumed, and where tier water volume and price thresholds are tied to the weather and, by definition, change on a daily basis. Further, it is also clear that a weather-based irrigation budget management approach which ignores or cannot account for the cost of water and the escalating financial penalties which may be associated with exceeding water volume thresholds also lacks a significant motivator to manage landscape irrigation efficiently and according to irrigation costs.

It should be appreciated that the establishment of tiered water prices not only establishes financial incentives for managing the landscape irrigation process according to the weather-based irrigation budget, but it also highlights a second separate but water cost related shortcoming of current irrigation budget based management practices. More specifically, for an irrigation budget, or a water budget as it may be referred to, to be an effective and advantageous tool in managing the volume and cost of water consumed for landscape irrigation, the irrigation budget over any period of time must be considered within the context of the water supplier's, i.e. the water district's billing period, or billing cycle and current irrigation budget based management practices are lacking in this regard. Water billing computations which are performed each billing period by the water district are typically performed without consideration of the irrigation water consumed or saved during previous billing periods, and as such, each billing period is a new and independent period during which actual water consumption is evaluated against the irrigation budget so that the district's water rate structure may be subsequently applied. The implication is clear. If the irrigator is not cognizant of, or fails to consider the water retailer's billing period begin and end dates, the irrigator runs the risk of failing to correct for excesses in irrigation within the billing period, and thus runs the risk of incurring higher than necessary water costs. For example and to demonstrate the severe shortcomings caused by failing to recognize the water retailer's billing period begin and end dates, consider the previously cited example where an irrigator has determined that the previous week's irrigation usage was 20% over the previous week's irrigation budget. If the irrigator is managing irrigation water consumption in order to avoid paying escalating prices for water consumption which has been deemed excessive by the water district, then it is not simply the previous week's 20% over budget situation that the irrigator must consider, but rather where with respect to the water billing period's irrigation budget the previous week's 20% excess has placed his or her water usage. If, for example, the water district's billing period ended during this same previous week where the 20% excess occurred, at least two things are true: first, the water district will and the irrigator should consider the summation of irrigation excesses and deficits that have occurred during the entire billing cycle and not just the previous week; and second, there is nothing that the irrigator can do in order to avoid any financial penalty that may be associated with excess consumption that occurred during the previous week because the previous week coincided with the end of the water district's billing period and the billing period's usage and associated costs have now already been incurred. If on the other hand the water district's billing period had only just begun during the same previous week where the 20% excess occurred, again at least two things are true: first the water district will and the irrigator should consider the summation of irrigation excesses and deficits that will occur during the entire billing cycle and not just the previous week; and second, the irrigator has only that amount of time remaining within the water district's billing cycle to make irrigation delivery system adjustments in an attempt to avoid any financial penalty that may be associated with excess consumption during the previous week and together with any irrigation deficits and excesses which may occur during the remainder of the billing cycle. While it may seem obvious that the irrigator should be managing water costs in synchronization with the billing practices of the water retailer, it should be appreciated that it is seldom if ever that water bills are sent directly to the landscape company by the water retailer because the landscape company, despite becoming ever more responsible for water costs, is not the water retailer's customer. Therefore, significant extra effort on the part of the professional landscape company or professional irrigation management company is required to obtain the water district's billing period for each irrigation budget managed landscape meter being managed by the professional landscape company. Furthermore, an understanding of the weather-based irrigation budget management process requirements and a general spirit of transparency is required of the water bill recipient in order for water billing information to be freely provided to the professional landscape company for irrigation management purposes. If water billing cycle information for each managed meter is not freely provided to the professional landscape management company as part of the general landscape management business process, then weather-based irrigation budget management cannot be properly performed.

Even if professional irrigators are cognizant of the potential escalating financial impact of over irrigation budget water consumption, i.e. over budget water consumption, when an over budget water consumption situation exists, and without the proper tools, it is very difficult for an irrigator to precisely determine the best downward irrigation system adjustment that should be made in order to avoid financial penalties. Again, and from the irrigator's perspective, the irrigator is constantly faced with competing objectives with regard to landscape irrigation management and overall landscape appearance. Consider again the previous example where an irrigator determines that for a particular landscape meter, the irrigation water that was consumed during the previous week was 20% over the previous week's weather-based irrigation budget. The irrigator must now determine not only how best to correct the previous week's excess, but how also to remain at or below the meter's irrigation budget over time while simultaneously continuing to keep the landscape plant materials adequately irrigated and in good appearance. The irrigator is thus challenged with determining how to adjust the irrigation system downward such that less water is delivered by the irrigation system while at the same time causing the least adverse effect on plant material health and appearance. To satisfy these competing objectives properly, and as has previously been discussed, the irrigator must consider several factors including current actual landscape meter water consumption against the meter's weather-based irrigation budget, water billing cycle end date, cumulative water cost within the billing cycle and within the tiered rate structure if applicable, the time of year, and the probable weather-based irrigation requirements between the current day and the end of the billing cycle. It should be appreciated that the last consideration presented above, i.e. the probable weather-based irrigation requirements between the current day, wherever the current day may fall within the billing cycle, and the end of the billing cycle are dynamic, and as a reference, can change as much as 40% within a single thirty day billing period. Further, and as has previously been described, the irrigator cannot know for certain what future ETo will be, and therefore cannot know for certain what future irrigation requirements will be, nor can the irrigator therefore know for certain what the future weather-based irrigation budget will be. The challenge is clear, irrigation system adjustment within the context and framework of weather-based irrigation budgets and tiered cost structures is complex with many variables and considerations, and current weather-based irrigation budget management practices do not have a mitigation strategy to improve this shortcoming.

Still yet another shortcoming in current weather-based irrigation budget management practices exists with regard to the amount of time required to execute the irrigation usage assessment and irrigation system corrective adjustment process. As previously described, and in practice, large landscapes are most often maintained and irrigated by professional landscaping companies. Professional landscaping companies will typically manage tens to hundreds and even thousands of individual landscapes, and thus employ a number of irrigators as required. In order to employ weather-based irrigation budget management practices, landscape companies often require twenty four to seventy two hours each week in order to manually collect water meter readings from each irrigation budget managed landscape meter, collect ETo data for each irrigation budget managed landscape, consolidate and organize the collected information so that the previous week's weather-based irrigation budget may be determined and so that actual water usage from the previous week may be evaluated against the previous week's irrigation budget for each irrigation budget managed landscape meter, analyze the results for each landscape meter, determine irrigation delivery system adjustment requirements for each landscape meter, distribute irrigation delivery system adjustment requirements to each landscape's responsible irrigator, and finally, allow ample time for each irrigator to re-visit each irrigation budget managed landscape in order to execute irrigation delivery system adjustments at each landscape meter as required. More to the point, the twenty four to seventy two hour period required to execute the irrigation usage assessment and irrigation system corrective adjustment portion of irrigation budget based management practices can consume as much as 43% (three days/seven days) of the week long period during which irrigators are expected to have already taken corrective actions and may leave only four days rather than the expected seven days for irrigation delivery system adjustments to have the desired effect.

Yet another rapidly evolving complexity induced shortcoming associated with current irrigation budget management practices is being caused by the general shift across the US toward budget based tiered water rate structures. As has previously been discussed, and while the shift toward tiered water rate structures appears to be having the desired effect of conserving irrigation resources, this shift has also begun to make irrigation cost management significantly more complex and unmanageable at the same time that the burden of irrigation cost management is being pushed to the professional landscape maintenance companies who have traditionally been responsible for maintaining landscape appearance only. More specifically and as previously discussed, as far as the professional landscape maintenance company and their irrigators are concerned, weather-based irrigation management practices must consider many things in addition to merely obtaining the weekly water volume usage at each meter and applying the correct irrigation budget calculation to each managed landscape meter. First, weather-based irrigation budget management practices must also consider each individual water district's water costs, and importantly, the tiered structure within which each water district's water costs are applied. Second, because weather-based irrigation budget tiered rate structures impose escalating rates based on cumulative water usage during a given billing cycle and because cumulative water usage begins anew with each new billing cycle, weather-based irrigation budget management practices must consider and be applied within the context of each individual water district's billing cycle for each managed meter. As straightforward as these two principles appear, the complexity becomes apparent when considered from the landscape company's perspective. As previously mentioned, professional landscape maintenance companies, or professional irrigation management companies will typically manage tens to hundreds and even thousands of individual landscapes, with each landscape having tens to hundreds of individual water meters to manage. Depending on the number of landscapes maintained and irrigated by a professional landscape company, it is likely that a professional landscape maintenance company will manage thousands of meters and irrigation systems which exist in anywhere from a few to many different water districts, and thus when executing a weather-based irrigation budget management process, will have to contend with a few to many different irrigation budget calculation methods and tiered rate structures, i.e. the water billing rules, or billing rules, which are typically unique to each water district. And finally, there is the water district billing cycle begin and end dates that must be considered when executing a weather-based irrigation budget management practices, and the billing cycle begin and end dates may be unique to each separate landscape maintained by the professional landscape company, with some individual landscapes even having multiple groups of water meters each with their own unique billing cycles. And thus it can be seen that weather-based irrigation budget management practices will continue to become more and more complex for professional landscape companies and their irrigators as more and more water districts move toward weather-based irrigation budgets and tiered rate water pricing, and without the proper management tools, weather-based irrigation management cannot be effectively performed.

Accordingly, there is a need for systems, devices, and methods for landscape management with predictive irrigation system adjustment index calculation capability that are forward looking to manage water usage in irrigation systems.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 is a block diagram of cloud computing based, irrigation billing cycle budget system with predictive irrigation system adjustment index output capability in accordance with some embodiments.

FIGS. 2-5, and FIGS. 7-25 are user interfaces of the cloud computing based, irrigation billing cycle budget system with predictive irrigation system adjustment index output capability in accordance with some embodiments.

FIG. 6 is the Map Edit Tool of the cloud computing based, irrigation billing cycle budget system with predictive irrigation system adjustment index output capability in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE DISCLOSURE

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Embodiments of the present disclosure include a web-based application software which utilizes an irrigation billing cycle budget calculation engine with predictive irrigation system adjustment index calculation capability in order to generate weather-based irrigation budgets for a given area or landscape, and evaluate actual water usage for the same given area or landscape in terms of water volume and water cost throughout a water billing cycle as defined by the water retailer who provides the irrigation water for the given landscape. Other embodiments may include mobile application software rather than a web-based application software as part of the systems, devices, and methods described herein. Persons of ordinary skill in the art would understand that any software or engine described herein may be part of a module as described in the present disclosure.

In addition, the application software also provides the software user with a predictive irrigation system adjustment index which, based on historical and current weather data, and/or forecasted weather data, the current water usage and water billing cycle will suggest to the user how the irrigation system should be adjusted to remain at or below the prevailing water district's irrigation budget in terms of water volume and water cost. The application software is a forward looking management tool used for the purposes of landscape irrigation management, landscape management and property management purposes in general.

Embodiments of the present disclosure include one or more servers implementing an irrigation billing cycle budget calculation engine that includes a water district database storing water rates, water rate structures, and water billing rules and water budget rules for each water district contained in the water district database; an evapotranspiration database storing weather data, and sourced or computed evapotranspiration data for projects contained within the project database; and a project database storing landscape area, landscape water meter descriptions, and water usage data for each water meter for each project which has been set-up and defined within the irrigation billing cycle budget calculation engine. The irrigation billing cycle budget calculation engine determines the irrigation budget for each individual water meter within the project database using the water billing and budget rules, evapotranspiration data that may include an evapotranspiration adjustment factor (ETAF), and water meter landscape area, and provides an assessment of irrigation water usage by water meter in terms of both water volume and water cost as compared to water meter irrigation budgets to a user computing device to be presented to a user as well as actual water usage compared to irrigation budget to user computing device to be presented to the user.

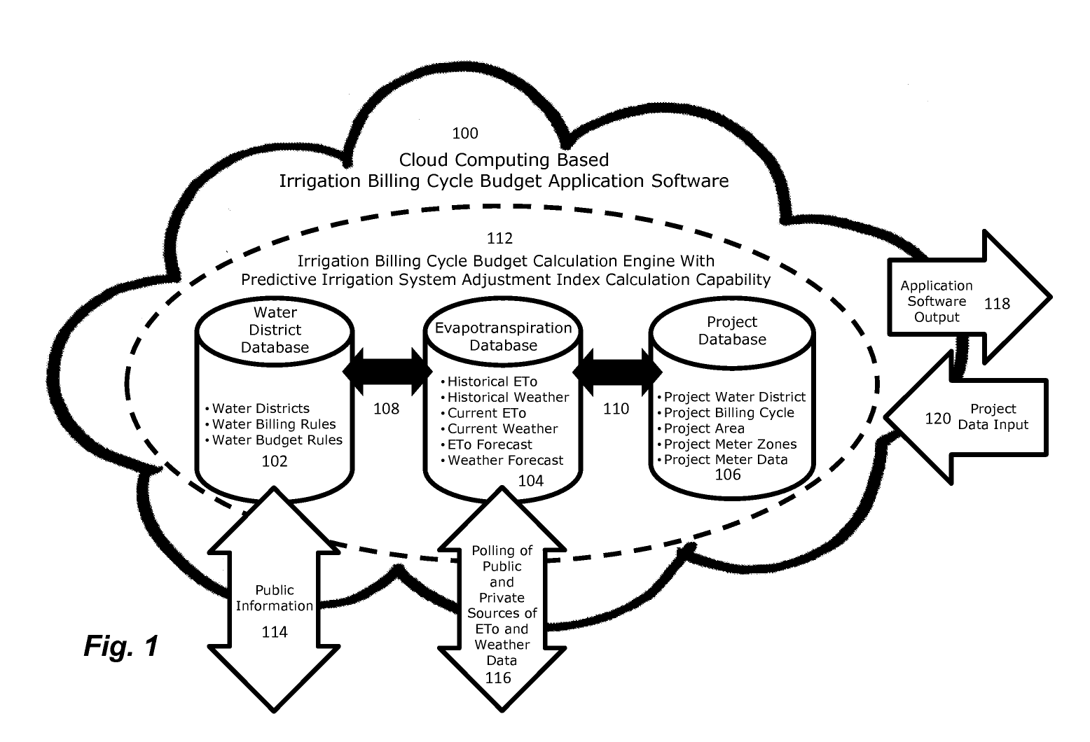

FIG. 1 is a block diagram of cloud computing based, irrigation billing cycle budget system 100 with predictive irrigation system adjustment index output capability in accordance with some embodiments. Further, FIG. 1 depicts a cloud diagram which contains application software (or simply the application) and which represents that the application operates on an Internet based cloud computing model where the application may operate on many different networked computers at the same time, for example the application may operate on Amazon's Amazon Web Services cloud computing infrastructure. Also contained within the cloud representation is a dotted line which encircles three separate databases, namely: the water district database 102, the evapotranspiration database 104, and the project database 106 which are each represented as cylinders within the depiction and labeled accordingly. Between the database representations are two-way arrows (108-110) which represent how data may be shared between each database. The databases provide the basic information used by the irrigation billing cycle budget calculation engine with predictive irrigation system adjustment index calculation capability, or irrigation billing cycle budget calculation engine, for several different computations. The database representations (102-106), and thus the irrigation billing cycle budget calculation engine 112, are encircled by a dotted line to indicate that the irrigation billing cycle budget calculation engine 112 is an independent code base which operates within and provides information to the cloud computing based irrigation billing cycle budget application software 100. Below the water district database 102 representation is a two-way arrow 114 of which one end passes into the cloud computing network and interfaces directly with the water district database 102. Below the evapotranspiration database 104 is a two-way arrow 116 of which one end passes into the cloud computing network and interfaces directly with the evapotranspiration database. To the right of the project database 106 is a one-way arrow 118 whose directional end passes into the cloud computing network and interfaces directly with the cloud computing based irrigation billing cycle budget application software, and also whose non-directional end originates from outside the cloud computing network. Also to the right of the project database 106 is a one way arrow 120 whose non-directional end originates from within the cloud computing based irrigation billing cycle budget application software, and whose directional end passes out of the cloud.

In addition, FIG. 1 shows the two-way arrow 114 associated with the water district database that depicts the fact that the typically publicly available water usage billing rules, which may vary from water district to water district, and which are used to calculate water usage bills must be input into the irrigation billing cycle budget calculation engine's water district database 102, and must also be updated from time to time as each water district's water rates and rate structures may change. The two-way arrow 116 associated with the evapotranspiration database 104 depicts the polling of public and private ETo data and weather data sources as performed by the irrigation billing cycle budget calculation engine in order to obtain current and historical ETo and weather data to populate the irrigation billing cycle budget calculation engine's evapotranspiration database 104. The one-way arrow 118 pointing into the cloud computing based irrigation billing cycle budget application software indicates how project information may be input into the irrigation billing cycle budget calculation engine's project database 106 through the application software within which the irrigation billing cycle budget calculation engine operates. The one-way arrow 120 pointing out of the cloud computing based irrigation billing cycle budget application software indicates that application software output is returned to the software user.

While a certain embodiment of the present disclosure is as depicted in FIG. 1 where the cloud computing based irrigation billing cycle budget application software 100, or the application software operates within a cloud computing based network accessible via the Internet and contains, and is thus provided information by the irrigation billing cycle budget calculation engine 112, it should be understood that other embodiments of the present disclosure do exist. In a second embodiment of the present disclosure, the irrigation billing cycle budget calculation engine 112 may be extracted from the application software 100 and placed on a microprocessor which is embedded within an irrigation controller. In such an embodiment, input into the irrigation billing cycle budget calculation engine 112 may be accomplished through the irrigation controller's user interface, or via cellular network or paging system network with which the irrigation controller is in regular communication. In such an embodiment, the irrigation billing cycle budget calculation engine's output would then be provided to the irrigation controller's embedded application software which operates the controller, and thus operates the irrigation system where the controller is located. It should be appreciated that the second embodiment of the present disclosure described above may be used to advantage by most any automatic irrigation control system such that the irrigation system water output is controlled and regulated based on the local, prevailing water retailer's water billing rules and water budget rules which may change from time to time for a number of reasons including but not limited to the water retailer's imposing of an irrigation standard to which landscape plant materials must comply.

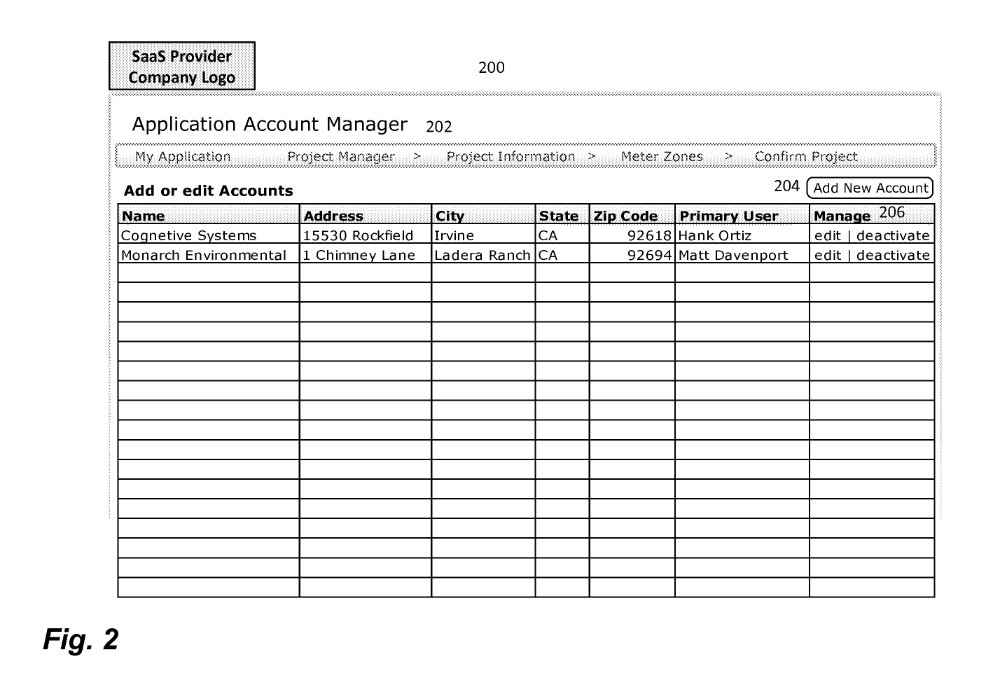

FIGS. 2-7 are user interfaces of the cloud computing based, irrigation billing cycle budget system with predictive irrigation system adjustment index output capability in accordance with some embodiments. Referring to FIG. 2, a user interface 200 rendering of a Service Provider's Account Manager page is shown which contains an Application Account Manager Table 202 where the Software as a Service Provider will enter specific details regarding each separate account, or Company Account which has been granted access to the application software as a service. The Account Manager Table contains columns where Company Account details are entered, and which details may include but are not limited to the name of the Company to which application software use has been granted, the Company's address details such as street address, city, state, and zip code, and the individual within the Company who is the primary individual software user, or Company Admin user. In addition to Company Account details, the table also contains a column which allows the Software as a Service Provider to edit and deactivate Company Accounts. Immediately above the Account Manager Table 202 and to the right is the Add New Account button 204, which when selected by the Software as a Service Provider will allow the Software as a Service Provider the ability to add new Company Accounts and thus grant additional Companies access to the application.

In addition, it is only the Software as a Service provider who has access to the application page shown in FIG. 2, and thus the only application user who is able to grant, edit and deactivate Company Accounts 206. Individual users within Company Accounts including Company Administrators users do not have access to this page of the application.

Also, in reference to FIG. 2, to edit an existing account, the Software as a Service Provider would select an account in the Account Manager Table, and then select the “Edit” button within the selected account's “Manage” column 206. When clicked, the Edit button will take the Software as a Service Provider to the selected account's My Application page within the application for editing. To deactivate an existing account, the Software as a Service Provider would select an account in the Account Manager Table, and then select the Deactivate button within the table's Manage column 206. When clicked, the Deactivate link will make the application unavailable to all application users associated with the now deactivated Company Account. To add a new account, the Software as a Service Provider would click the Add New Account button 204 in the upper right hand corner above the Account Manager Table 202. When clicked, the Add New Account button 204 will generate a new My Application page which will from that point forward correspond to the new Company Account, and the new Company Account's unique application instance.

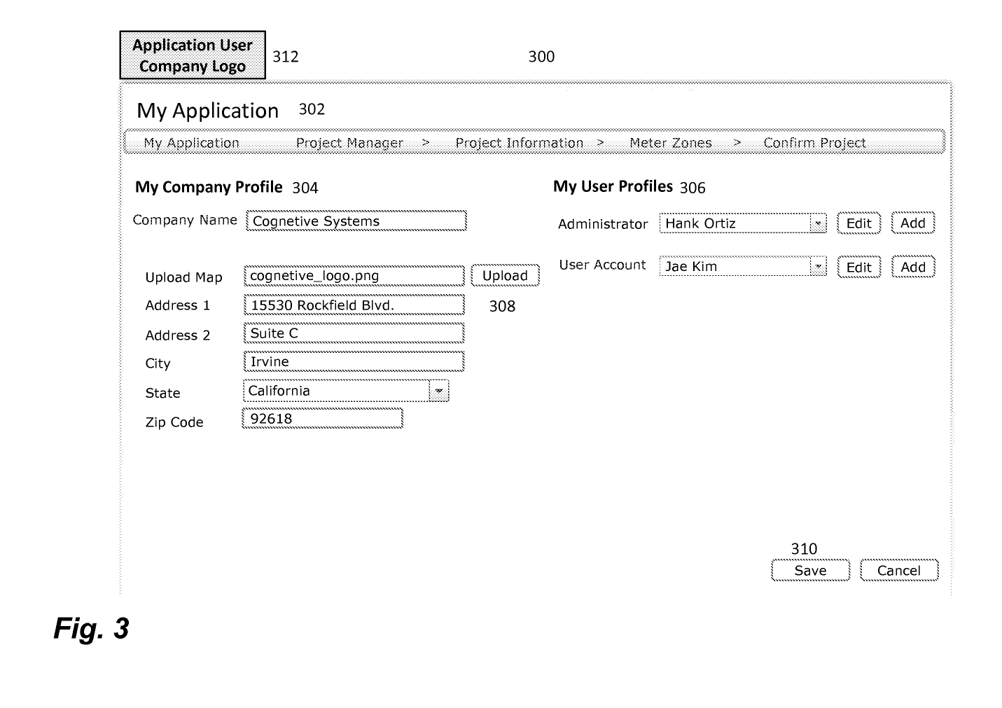

Referring to FIG. 3, there is shown a user interface 300 rendering of the present disclosure's My Application page 302. The My Application page contains several fields for information entry under the My Company Profile 304 heading in the left hand side of the page, and also several fields for information entry and selection under the My User Profiles 306 heading in the right hand side of the page.

In further reference to FIG. 3, the My Application page 302 is the destination page within the application when the Software as a Service Provider desires to create a new Company Account, or to edit an existing Company Account. It should be pointed out that the Software as a Service Provider always has access to all pages of each unique instance within the application. A Company to whom application access has been granted, on the other hand, will only ever have access to application pages within the unique application instance associated with that Company. Although both the Software as a Service Provider and the Company or Companies to whom application access has been granted will have access to their corresponding My Application pages 302, it is only the Software as a Service provider who has access to the information entry fields on the left hand side of the page and underneath the My Company Profile 304 heading. Both the Software as a Service Provider and the Company or Companies to whom application access has been granted will have access to data entry fields on the right hand side of the page and underneath the My User Profiles 306 heading.

In addition, at account creation, the Software as a Service Provider enters the Company's address information in the information entry fields underneath the My Company Profile 304 heading, and by clicking the upload button 308, proceeds to upload a digital file of the Company's company logo. Upon entering the required information cited above, the Software as a Service Provider selects the Save button 310 in the lower right hand corner of the My Application page. This completes the Company Account creation process and generates a unique application instance associated with the Company Account. Once a digital file of the Company's logo has been uploaded into the application, and the Company's unique instance has been created, each page of the application associated with a unique instance will display the Company logo also associated with the unique instance in the upper left hand corner as is depicted in FIGS. 3-5, and FIGS. 7-25 in the box labeled Application User Company Logo 312. Once the Company Account has been created, the Company's Admin User will have access to this page and the rest of the application unique instance. The My User Profiles 306 section is used to generate additional individual user accounts within the Company Account if so desired.

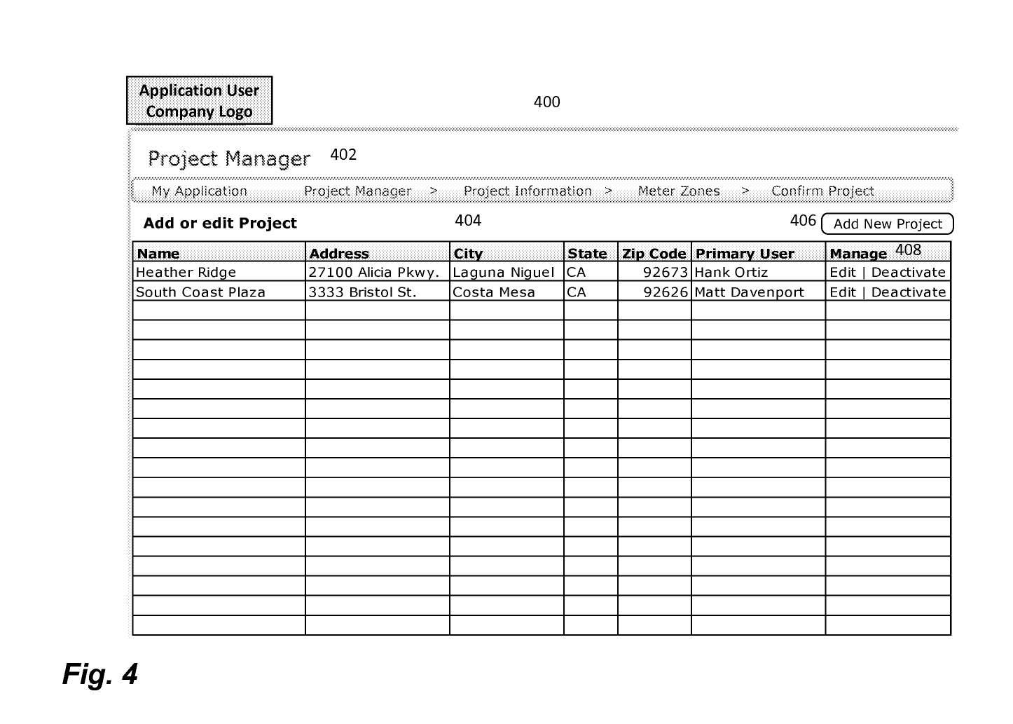

Referring to FIG. 4 there is shown a user interface 400 rendering of the present disclosure's Project Manager page 402. This page of the application looks substantially similar to the page depicted in FIG. 2, however rather than containing an Account Manager Table as does the rendering in FIG. 2, the rendering in FIG. 4 contains a Project Manager Table 404 where the Company Admin User will enter details regarding each separate project managed by the Company and the application software. The Project Manager Table 404 contains columns where project details are entered, regarding the different projects managed by the application and which may include but are not limited to containing the name of the project, the project's address details such as street address, city, state, and zip code, and the individual within the Company who is the primary individual user with respect to an individual project. In addition, the table also contains a Manage column 406 which allows the Company's Admin User to edit and deactivate projects. Just above the table and to the right is an Add New Account button 406 which when selected by the Admin User will allow the Admin User the ability to add new projects within the application.

In further reference to FIG. 4, it is only the Company Admin User who has access to the Project Manager page 402, and thus the Admin User is the only user within the Company who is able to add, edit and deactivate projects. Individual users within Company Accounts do not have access to this page of the application.

In addition, to edit an existing project, the Company Admin User would select any project in the Project Manager Table 404, and then select the “Edit” button within the selected project's “Manage” column 408. When clicked, the Edit button will take the Admin User to the selected project's Project Information page within the application for editing. To deactivate an existing project, the Admin User would select a project in the Project Manager Table 404, and then select the Deactivate button within the table's Manage column 408. When clicked, the Deactivate button will make the project unavailable to all Company users within the selected account, except for the Company Admin User who always has access to every page within the Company unique application instance, unless the entire Company Account has been deactivated by the Software as a Service Provider and in which case no one but the Software as a Service Provider will have access. To add a new project, the Admin User would click the Add New Project link 406 in the upper right hand corner above the application Project Manager Table. When clicked, the Add New Project link 406 will generate a new Project Information page which will from that point forward correspond to the new project, and the new project's unique landscape details.

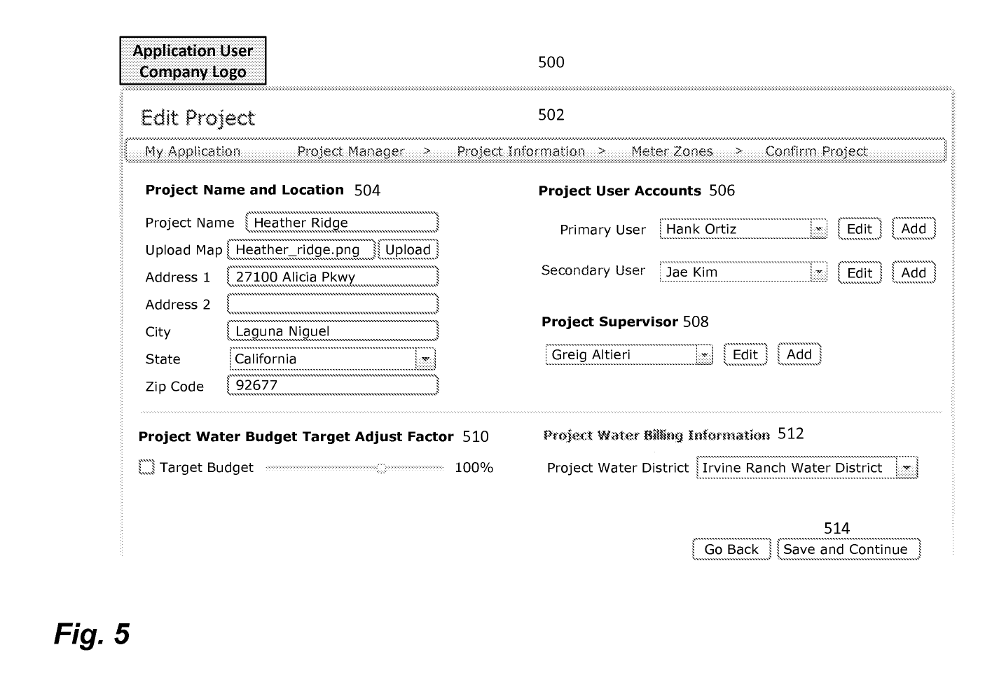

Referring to FIG. 5 there is shown a user interface 500 rendering of the present disclosure's Project Information page 502. The Project Information page 502 contains five different subsections each with a separate heading as depicted and namely: 1) Project Name and Location 504, 2) Project Water Budget Target Adjust Factor 510, 3) Project User Accounts 506, 4) Project Supervisor 508, and 5) Project Water Billing Information 512. Each Project Information page subsection contains fields and/or drop down menus and/or selectors for information entry and selection that is associated with the subsection heading.

In further reference to FIG. 5, the Project Information page 502 is the destination page within the application that a Company's Admin User desires to reach in order to create a new project, or to edit an existing project. At project creation, the Admin User creating the project enters the required project name and location information in the information entry fields underneath the Project Name and Location heading 504, and may also upload a digital reference map of the project. The Admin User creating the project may then define additional individual users who will have access to the project being created by entering the required information underneath the Project User Accounts heading 506. The Admin User creating the project will then define the Project Supervisor responsible for the project being created by entering the required information underneath the Project Supervisor heading 508. The Admin User creating the project will then, optionally and as required for any number of reasons, refer to the Project Water Budget Target Adjust Factor section 510 and if so desired, may select a Water Budget Target Adjust Factor. For example, for special requirements and added irrigation consumption control, the Admin User may select a Water Budget Target Adjust Factor of 50%. The effect of a 50% Target Adjust Factor is that the software application may view any volume of water slightly over 50% of the maximum recommended volume prescribed by the water retailer as an over budget condition, and may accordingly alert users to this over adjusted-budget condition. Alternatively, and if the landscape plant materials are new and under establishment, the Admin User may determine that a temporary Water Budget Target Adjust Factor of 120% is required. The effect of a 120% Target Adjust Factor is that the software application may view any volume of water below 120% of the maximum recommended volume prescribed by the water retailer as a within adjusted-budget condition. The Admin User creating the project will then, underneath the Project Water Billing Information heading 512, select the water retailer or water district which supplies irrigation water to the project from a drop down list which contains a comprehensive list of water districts throughout the US. This completes the first step in creating a project within the application, and when the Admin User creating the project has completed entering and identifying information about the project within this page, the Admin User may save the information to the application by selecting the save and continue button 514 located in the lower right hand corner of the page.

In addition, and with reference to the Project Water Billing Information section 512 of the Project Information page 502 where the Admin User selects the water retailer that supplies irrigation water to the project being created, it should be pointed out that this has the effect of also assigning the water district and the district's water rates, water rate structures, and water budget rules to the project being created. While not visible to users through the application's user interface, the application operates in conjunction with an irrigation billing cycle budget calculation engine as depicted in FIG. 1. As depicted in FIG. 1, the irrigation billing cycle budget calculation engine contains a water district database which contains the water rates and rate structures for each water district available in the in the project water district drop down menu depicted in FIG. 5. For example, Water District XYZ which may be included in the water district drop down menu present in FIG. 5 may have the following irrigation budget based tiered rate structure, i.e. billing rules, which would be included in the irrigation billing cycle budget calculation engine's water district database: Tier 1=Usage of 0-40% of Irrigation Budget=Cost of $1.00/Hundred Cubic Feet of Water Used; Tier 2=Usage of 41-100% of Irrigation Budget=Cost of $1.50/Hundred Cubic Feet of Water Used; Tier 3=Usage of 101-110% of Irrigation Budget=Cost of $2.00/Hundred Cubic Feet of Water Used; Tier 4=Usage of 111-120% of Irrigation Budget=Cost of $4.00/Hundred Cubic Feet of Water Used; Tier 5=Usage of 121%+of Irrigation Budget=Cost of $8.00/Hundred Cubic Feet of Water Used.

As an example of how the irrigation billing cycle budget calculation engine, and thus the application use billing rules that have been entered into the water district database, it can be seen that if and when a project managed by the application is also supplied irrigation water by Water District XYZ, the application software may call on the irrigation billing cycle budget calculation engine and thus the water district database to obtain the irrigation budget based, i.e. budget based, tiered pricing structure for Water District XYZ as cited above so that the water cost associated with the landscape water consumed at each project water meter may at any point in time be computed based on Water District XYZ's water billing structure.

In further reference to FIG. 5, the water district database also contains the water budget calculation method and rules used by each different water district contained in the database. It has been previously stated that a general equation for calculating an irrigation budget is: Irrigation Budget=ETo*ETAF*LA. Where: ETo (Reference Evapotranspiration)=the amount of water which evaporates naturally from a given landscape, plus the amount of water which would naturally transpire through a hypothetical turf reference crop standard if the given landscape were completely covered with the turf reference crop, for example. ETo is highly dependent on the local weather and time of year; ETAF=the ETo Adjustment Factor which varies according to the landscape's true irrigated plant materials and time of year; LA=Landscape Area to be Irrigated.

It should be appreciated that while ETo is based primarily on weather, season, and geographical location, and that Landscape Area is a constant which may be obtained by measuring a landscape, the ETAF variable is often determined by the water district according to the needs and characteristics of the water district's service area. In some cases and according to will or need, a water district may even choose to include additional factors and coefficients such as an arbitrary, standard irrigation system efficiency factor when defining a budget based water rate structure. Therefore, the water district database must also contain the proper irrigation budget equation used by each different water district contained in the water district database.

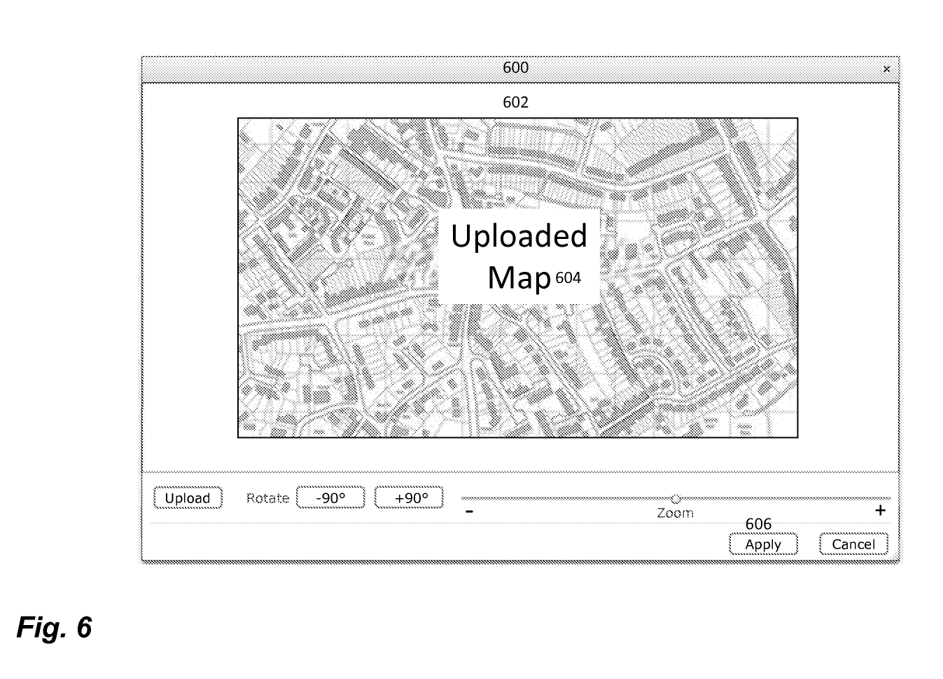

Referring to FIG. 6 there is shown a user interface 600 rendering of the present disclosure's Map Edit Tool page 602. The Map Edit Tool page 602 contains a near full screen area in which the previously uploaded project map 604, or any subset of the project map may be displayed for editing. The Map Edit Tool page 602 also contains controls for editing the uploaded map 604 which include but are not limited to crop, rotate and zoom tools as depicted in FIG. 6.

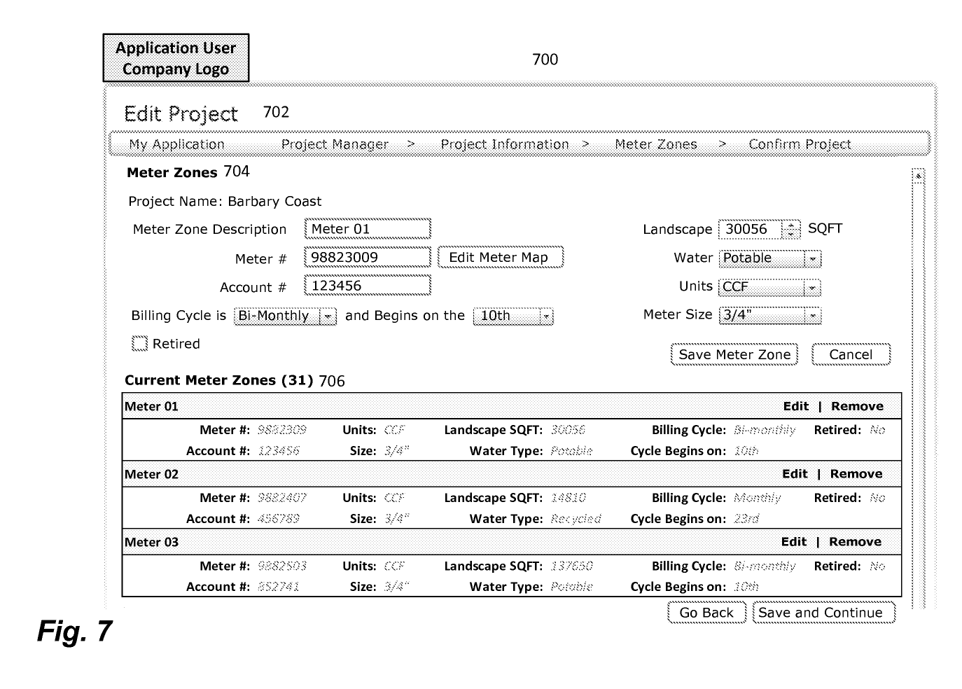

In further reference to FIG. 6, the Map Edit Tool 602 may automatically launched by the application if and when either the Upload button as depicted in FIG. 5 is selected, or the Edit Meter Map button as depicted in FIG. 7 is selected, and is the desired destination within the application when map editing is required. During project creation, a digital map of the project is uploaded as has been described for FIG. 5. Upon completion of the uploading of the map during project creation, the Map Edit Tool 602 will automatically launch and display a picture of the uploaded project map 604 as depicted in FIG. 6. The Company user, either the Company Admin User, or a different individual Company user as identified in the application Project Information page, who is creating the project may edit the uploaded map by cropping, rotating, or zooming. Map editing is performed so that, regardless of the size and proportion of the uploaded map 604, the uploaded map 604 may be edited to suit the best needs of the user within the application. For example, the user may want to rotate the map so that the map aspect ratio better fits the application, or the user may want to crop extraneous information from the map. When the application user is satisfied with the map editing results, the application user will select the Apply button 606 in the lower right hand corner of the map so that map editing results are saved to the application.

Referring to FIG. 7, there is shown a user interface 700 rendering of a Project Meter Zones page 702. This page 702 is used by the Admin user to define characteristics for each water meter within a project when a project is set-up in the application. The meter characteristics are used by the application software in subsequent calculations performed by the application software. The Project Meter Zones page 702 contains two different subsections each with a separate heading as depicted and namely: 1) Meter Zones 704, and 2) Current Meter Zones 706. The Project Meter Zones page's 702 top subsection labeled Meter Zones 704 contains meter description tools such as data entry fields, check boxes and drop down menus used for describing each individual project meter zone as it becomes added to a project during set-up, and also an Edit Meter Map button. Below the Meter Zones subsection 704 of the Project Meter Zones page 702 is the Current Meter Zones subsection 706 which contains a table in which all meter zones which have been defined for the project are listed together with each meter's respective defining characteristics.

In further reference to FIG. 7, the Project Meter Zones page 702 is the destination page within the application software when an application user desires to define a project's meter zones, or edit an existing project's meter zones. With regard to the Meter Zones subsection, a meter zone definition may include but is not limited to: 1) a data entry field used for describing or naming the meter zone with a common name, such as Meter 01, 2) a data entry field for identifying the meter zone by the same reference as the water retailer, for example the meter ID number, 3) a data entry field for identifying the meter zone account number which has been assigned to the meter zone by the water retailer, 4) a drop down menu for selecting the billing cycle period, or billing cycle, i.e. monthly or bi-monthly, 5) a drop down menu for selecting the date that the billing cycle typically begins, 6) a check box for indicating if and when a particular meter has been retired, i.e. is no longer in service, 7) a data entry field in which the landscape area may be entered, 8) a drop down menu for selecting the type of water delivered at the water meter, i.e. potable or recycled, 9) a drop down menu for indicating the water meter's units of measure, i.e. cubic feet, or CF, 100 cubic feet or CCF, etc, 10) a drop down menu for indicating the water meter size, i.e. the diameter of pipe across which the water meter measures water volume over time. Further, the description of the meter zone may also include the assignment to the meter zone of a digital map of the meter zone. Meter zone maps are subsets of the project map which has been previously uploaded during completion of the Project Information page. Meter zone map assignment is accomplished by selecting the Edit Meter Map button which is also present underneath the Meter Zones subsection of the Meter Zones Definition page. Selecting the Edit Meter Map button launches the application's Map Edit Tool with the entire project map preloaded in the tool for cropping and editing such that only the project map subsection which is associated with the particular meter zone being defined may be selected and assigned to the particular meter zone being defined. Once the user has completed entering a meter zone definition, the user will select the Save Meter Zone button which is at the bottom right of the Meter Zones definition entry fields. This saves the meter zone information to the application for future use. The user may continue this process of identifying and defining meter zones until every meter zone within the project has been defined and saved to the application. With regard to the Current Meter Zones subsection 706 of the Meter Zones page, there is a table which displays each meter zone which has been defined for the project together with each meter zone's corresponding definition data which has been saved within the application. Each meter zone's entry in the Current Meter Zones table 706 also has an edit button and a remove button as depicted. If the edit button is selected for a particular meter zone, the meter zone's definition data will appear above in the Meter Zones subsection 704 of the Meter Zones page 702 and will become available for editing. Upon completion of any editing, the user will again select the Save Meter Zone button so that the edited meter zone information is saved to the application. If the remove button is selected for a particular meter zone, the entire meter zone's entry and definition data will be deleted from the application.

In further reference to FIG. 7, it should be appreciated that the data entry fields, drop down menus and check boxes which are present and depicted in the Meter Zones subsection 704 of the Meter Zones page 702 of FIG. 7 is not meant to be an exhaustive list of all of the types of information that may be added to the application's Meter Zones page 704, and therefore the disclosure of FIG. 7 is not limited to only what has been depicted in FIG. 7. Examples of additional information which may also be included as data entry fields in the Meter Zones page 702 include, but are not limited to: irrigation controllers, sprinklers, landscape tree inventory or the inventory of other high value landscape plant materials, articles, or objects etc., and the global positioning system (GPS) coordinates of each inventoried object. Further, additional detail regarding the tree inventory or other high value landscape plant material inventory such as plant material care and maintenance directions, for example the tree pruning and regular maintenance schedules, etc. may also be entered into the application's Meter Zones page 702. It should be appreciated that the Meter Zones page 702 may contain data entry fields for any number of objects which are part of landscapes and properties in general which are managed by the application software and which may be better managed to the advantage of application users by inclusion of said objects into the application's Meter Zones page 702, for example, the Meter Zones page 702 may also include other property features such as hardscape fixtures, fountains, pools and pool equipment, lights and lighting controllers, etc.

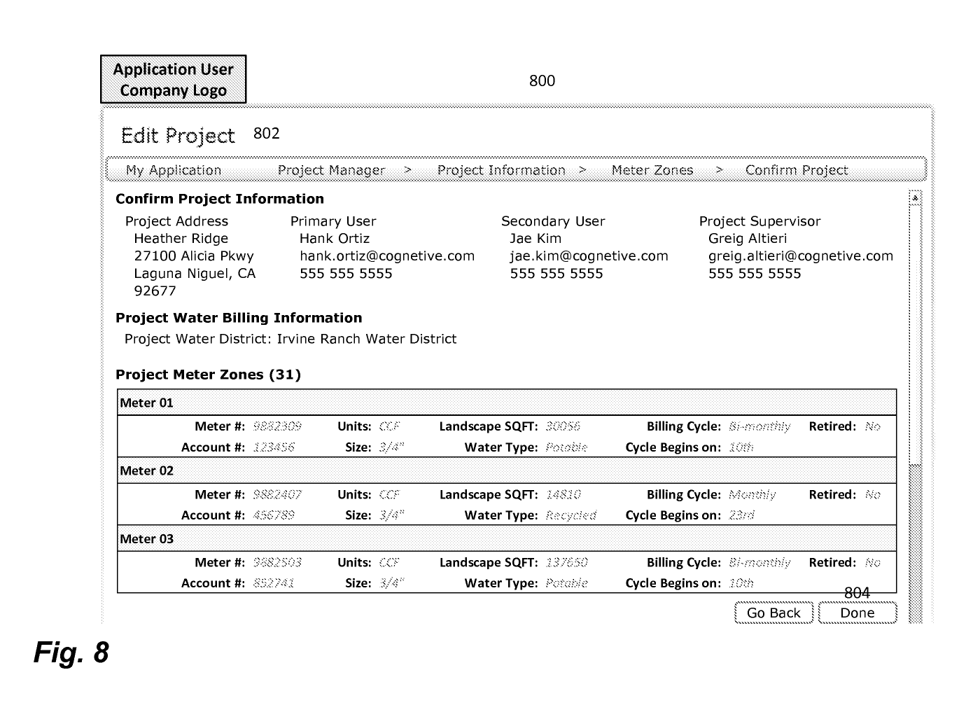

Referring to FIG. 8 there is shown a user interface 800 rendering of the present disclosure's Project Confirmation page 802. The Project Confirmation page 802 contains six subsections, namely: 1) Project Address, 2) Primary User, 3) Secondary User, 4) Project Supervisor, 5) Project Water Billing Information, and 6) Project Meter Zones. The Project Confirmation page 802 is the destination page within the application when the user desires to review and then either edit or confirm all of the information which has been previously entered into the application and which defines the entire project. Upon review of the information, if the user notices that errors which require editing exist, then the user will select the Go Back button at the bottom of the Project Confirmation page 802 to return to either the application's Project Information page, or Meter Zones Page in order to make the desired corrections. If and when the user is satisfied with the information that is presented in the Project Confirmation page 802, the user will select the Done button 804 at the bottom of the Project Confirmation page 802. This concludes the process for defining a project within the application.

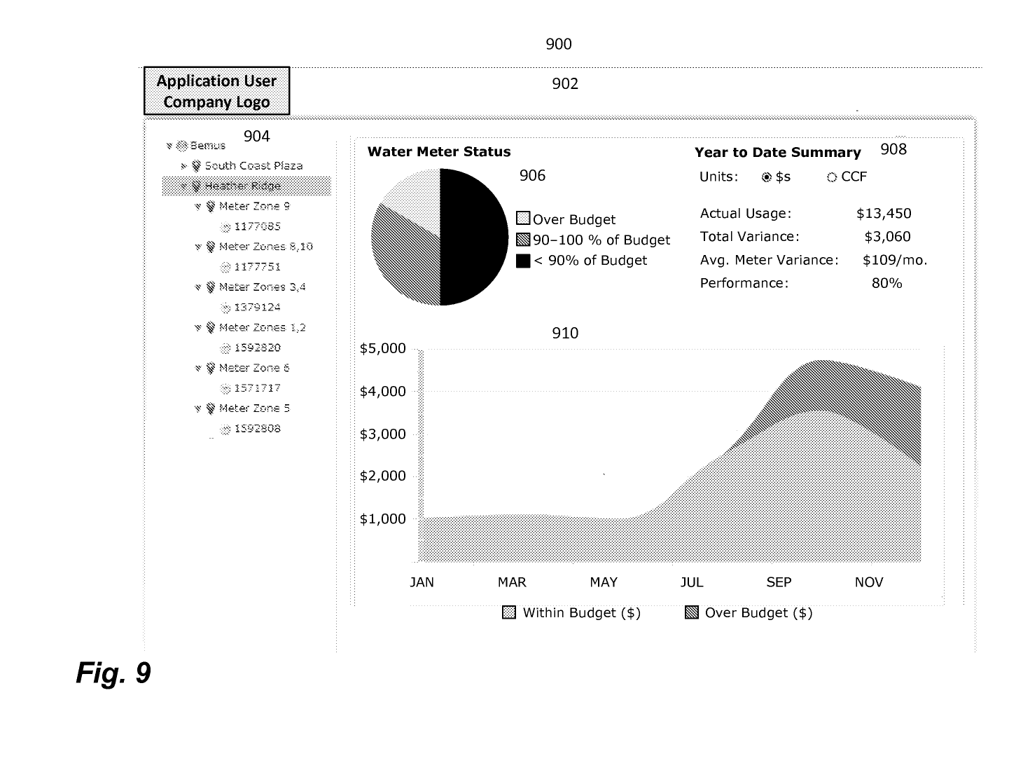

Referring to FIG. 9, a user interface 900 rendering of the present disclosure's Dashboard page 902 is shown. The Dashboard page 902 contains a Selection Tree 904 in the left hand side of the Dashboard. The Dashboard also contains three different sections, namely: 1) The Water Meter Status Pie Chart 906, 2) The Year to Date Performance Summary Table 908, and 3) A Rolling 12 Month Actual Water Usage Area Chart 910

In further reference to FIG. 9, the Dashboard page 902 is the application's destination page when an application user desires to see a summary of project water usage statistics. The Dashboard page 902 contains a Selection Tree 904 in the left hand side of the page which is hierarchical in nature and provides a means of selecting which managed projects, and thus which water meter data the application should use to derive the Dashboard page's 902 charts and table. Within any unique Company instance of the application, the highest level of the Selection Tree 904 is the Company which has been granted access to the application and who is operating the unique instance. Any level of the Selection Tree 904 may be highlighted by clicking on the Selection Tree level. Highlighting the highest level of the Selection Tree 904, or the Company level will direct the application to consider data from all Company projects managed by the application instance to be used to derive the values represented in the Dashboard charts and table. If only a single project is highlighted in the Selection Tree, then only data from each water meter associated with the highlighted project will be used to derive the values represented in the Dashboard charts and table. It is possible to select just one meter from within a project, just one single project, or many different projects as desired. To the right of the Selection Tree 904 is the Dashboard page Charting and Table Area in which there are two different charts, namely: 1) the Water Meter Status Pie Chart 906, and 2) the rolling 12 Month Actual Water Usage Area Chart 910, and also 3) the Year to Date Performance Summary Table 908.

In addition, the Water Meter Status Pie Chart 906 has three shaded slices: Meters at less than 90% of Budget (black slice). This slice represents the total number of meters whose readings are at or below 90% of the irrigation budget as of the most current water meter data which has been entered into the application. Meters at 90-100% of Budget (dark gray slice). This slice represents the total number of meters whose readings are greater than 90% of the irrigation budget, but still less than 100% of the irrigation budget as of the most current water meter data which has been entered into the application. Meters over Budget (light gray slice). This slice represents the total number of meters whose readings are over the irrigation budget as of the most current water meter data which has been entered into the application. There is a chart legend to the right of the Water Meter Status Pie Chart 906 as depicted.

The calculations performed by the application for each pie slice of the Water Meter Status Pie Chart 906 are based on the total number of water meters which are represented by the projects that have been selected in the Selection Tree 904. The calculations performed by the application for the Water Meter Status Pie Chart 906 are: Given that (total meters)=the number of meters as represented by each selected project in the Navigation Tree; Given that (total meters at less than 90% of irrigation budget)=a subset of (total meters); Given that (total meters at 90-100% of irrigation budget=a subset of (total meters); Given that (total meters over irrigation budget)=a subset of (total meters). Meters at less than 90% of irrigation budget slice=(total meters at less than 90% of irrigation budget)/(total meters)*100. Meters at 90-100% of Budget slice=(total meters at 90-100% of irrigation budget)/(total meters)*100. Meters over Budget slice=(total meters over irrigation budget)/(total meters)*100.

In further reference to FIG. 9, The Year to Date Summary Table 908 contains an area for selecting the units in which the Dashboard charts and table will report. Selecting the units in which the Dashboard will report is performed by selecting either of the two radio buttons which are labeled $s (dollars) and CCF (hundreds of cubic feet of water) respectively. Additionally, the Year to Date Summary Table 908 contains four sections, namely: 1) Actual Usage, 2) Total Variance, 3) Average Meter Variance, 4) Performance.

The calculations performed by the application for each section of the Year to Date Summary Table 908 are based on the water meters which have been selected in the Selection Tree 904. The calculations performed by the application for the Year to Date Summary Table 908 when the user has selected CCF as the units in which the Dashboard should report are: 1) Actual Usage is equal to the total volume of water in hundreds of cubic feet, or CCF, consumed by the meters which have been selected in the Selection Tree 904 and for the current calendar year as of the most current water meter data which has been entered into the application, 2) Total Variance is equal to, on an individual meter by meter basis and according to the meters which have been selected in the Selection Tree 904, the summation of the total volumes of water in CCF, if any, which are over the irrigation budget at the end of each selected meter's billing cycle for the current calendar year, 3) Average Meter Variance is equal to, and according to the meters which have been selected in the Selection Tree 904, (Total Variance)/[(Total Number of Meters represented in Total Variance)*(Total Number of Year to Date Completed Meter Billing Cycles)], and 4) Performance is equal to, and according to the meters which have been selected in the Selection Tree 904, [(Total Number of Year to Date Completed Meter Billing Cycles during which the water usage was within the irrigation budget))/(Total Number of Year to Date Completed Meter Billing Cycles). It should be pointed out that if the user had selected $s as the unit in which the Dashboard should report rather than CCF, the Same calculations would be performed by the application as cited above, however the resulting water volumes, on a meter by meter basis, would then be processed by the application software and according to the applicable water district billing rules as required and according to the meters that had been selected in the Selection Tree 904 so that the calculation results will be reported in $s.

In further reference to FIG. 9, the rolling 12 Month Actual Water Usage Chart 910 at the bottom of the Dashboard page 902 is a stacked area chart which is a composite of consumed water which is under the irrigation budget and is represented by the light gray area, and consumed water which is over the irrigation budget and is represented by the dark gray area above the light gray area. The 12 Month Actual Water Usage Chart 910 depicts the current and previous 11 months' worth of water consumption data and will include the most current water meter data which has been entered into the application and according to the meters which have been selected in the Selection Tree 904. The 12 Month Actual Water Usage Chart's x-axis is time in months, and the y-axis is in the Dashboard unit of measure which has been selected by the user, i.e. either $s or CCFs, and the Chart also has a legend as depicted.

The calculations performed by the application for each area of the 12 Month Actual Water Usage Chart 910 are based on the water meters which have been selected in the Selection Tree 904. The calculations performed by the application for the 12 Month Actual Water Usage Chart 910 when the user has selected CCF as the units in which the Dashboard should report are: Within Budget Area is equal to, on an individual meter by meter basis, the summation of the total volumes of water consumed which are within the irrigation budget at the end of each meter's billing cycle for the current and previous 11 months, and the Over Budget Area is equal to, on an individual meter by meter basis, the summation of the total volumes of water consumed, if any, which are over the irrigation budget at the end of each meter's billing cycle for the current and previous 11 months. It should be pointed out that if the user had selected $s as the unit in which the Dashboard should report rather than CCF, the same calculations would be performed by the application as cited above, however the resulting water volumes, on an individual meter by meter basis, would then be processed by the application software and according to the applicable water district billing rules as required and according to the meters that had been selected in the Selection Tree 904 so that the calculation results will be reported in $s.

In still further reference to FIG. 9, and with regard to computations which include summations of over and under irrigation budget volumes of water or the costs of over and under irrigation budget volumes of water, i.e. summations of water usages, it should be appreciated that the disclosed application software treats water usage on an individual meter by meter basis, and that when combining water usages of multiple meters, even for meters within the same landscape and during the same billing period, does not allow the difference between actual water usage and the budgeted usage for any one meter, whether positive or negative, to offset the difference between actual water usage and the budgeted water usage of another meter, whether positive or negative. Instead, and when combining either the volumes or costs of water usage of multiple meters, all over irrigation budget usages of individual meters are summed and reported as the total over budget volume or cost of the multiple meters, and all at or under irrigation budget usages of individual meters are summed and reported as the total at or under budget usages of the multiple meters, without the difference between the irrigation budget and the actual usage of any one meter, whether positive or negative, being used to offset the difference between actual water usage and the budgeted water usage of another meter, whether positive or negative. For example, if a water meter A within a landscape is under budget by 5 CCF at the conclusion of a given billing period, and a second water meter B within the same landscape and at the conclusion of the same given billing period is over budget by 5 CCF, the net water usage of water meters A and B combined with respect to the budgeted usage of water meters A and B combined does not result in a net at or under budget water usage between meters A and B, but rather the net usage of meters A and B combined will result in a net over budget usage of 5 CCF and a net at or under budget usage of the at or under budget usages of meters A and B combined. The reason that the disclosed application software treats the summations of usages of multiple meters in the manner described is that, typically and in the purview of the water retailer or water district, meters A and B are separate accounts which are billed separately even though they are within the same landscape, and thus the difference between actual water usage and the budgeted usage for meter A, whether positive or negative will not be used by the water district to offset the water usage of meter B, whether positive or negative even though meters A and B are within the same landscape. Importantly, the treating of meters on an individual basis during computations as described, and in the same manner that is typical of water districts is an improvement over irrigation management practices which, when assessing irrigation performance for multiple meters, an entire landscape, or even multiple landscapes, sum all water meter over and under budget usages allowing the difference between actual water usage and the budgeted usage for any one meter, whether positive or negative, to offset the difference between actual water usage and the budgeted water usage of another meter, whether positive or negative for all meters within a given assessment which tends to mask over budget usages and costs that in fact may exist, and to advantage, may become exposed by the disclosed application software as described.

In additional reference to FIG. 9, it should be appreciated that the application software's Dashboard charts are not limited to the charts which have been described in the foregoing description, and that the examples depicted in FIG. 9 and the accompanying descriptions are meant to represent an example of the types of data that may be output and presented by the application. Examples of other types of output which may also be presented in the application software's Dashboard page 902 include, but are not limited to: an annual water budget forecast, landscape asset location in map form, total asset count and value, landscape maintenance schedules and reminders, open work order summaries, and any other data that is useful in maintaining and managing landscapes in general.

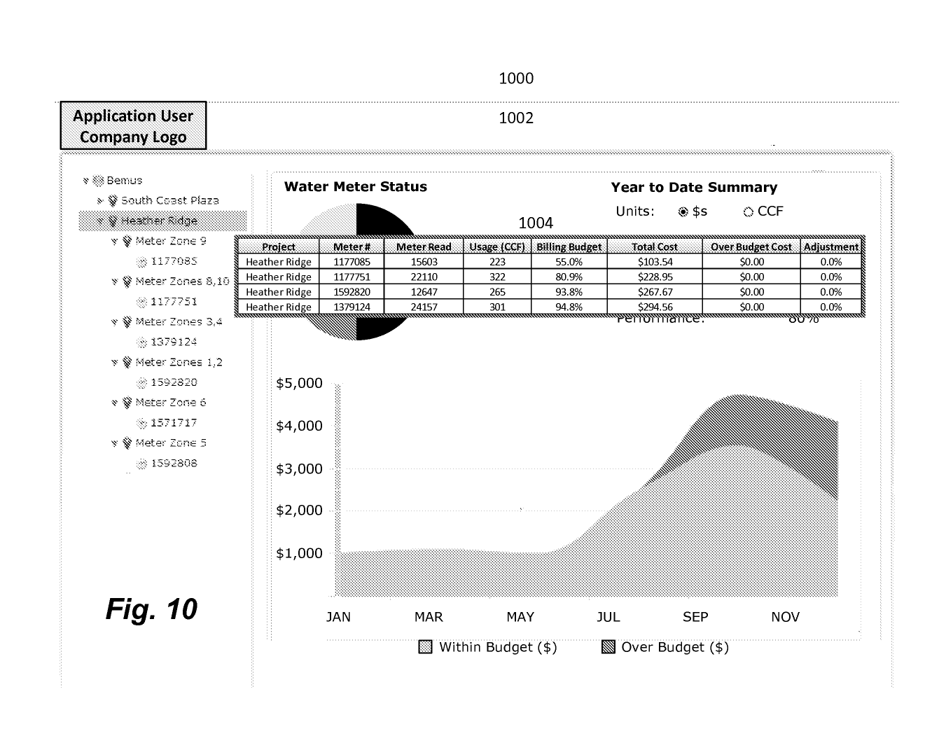

Referring to FIG. 10, a user interface 1000 rendering of the present disclosure's Dashboard page 1002 after having executed a computer mouse double-click in order to pop-up additional more detailed information is shown. FIG. 10 depicts the same application Dashboard view as in FIG. 9, however, the application Dashboard has now become grayed out and a pop-up table 1004 containing detailed water meter data has been generated in the foreground.

In further reference to FIG. 10, double clicking with a computer mouse any pie slice within a pie chart generates a pop-up list of meters and associated meter data which is used to derive the pie slice. The meter data which is depicted in the pop-up table in FIG. 10 includes: Project Name; Meter Number; Current Meter Read Value; Water Usage in CCF; Billing Budget; Total Cost; Over Budget Cost; Adjustment Index. Other meter data which may also be depicted includes but is not limited to: Water Usage (in dollars); Water Budget (in dollars); Previous Meter Read Value; Current Meter Read Date; Previous Meter Read Date.

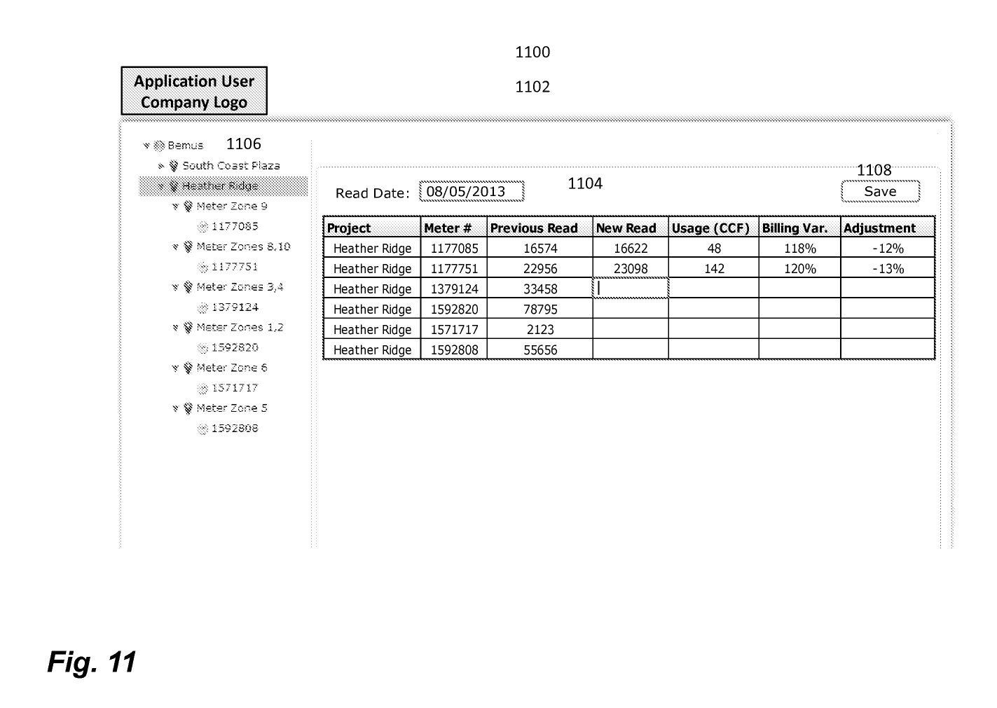

Referring to FIG. 11, a user interface 1100 rendering of the present disclosure's Water Meter Data Entry page 1102 is shown. The application's Water Meter Data Entry page 1102 contains a Selection Tree 1106 in the left hand side of the page and a Data Entry Table 1108 which occupies most of the remainder of the page as is depicted in FIG. 11. Above the Data Entry Table 1104 is a Read Date entry field where, if by manual data entry, the user who is entering meter reading data into the table will select the reading date which corresponds to the meter reading data being entered. Above and to the right of the Data Entry Table 1104 is a Save button 1108 which is used to Save entered meter reading data to the application software.

In further reference to FIG. 11, the Water Meter Data Entry page 1102 is the destination page within the application when an application user desires to enter or edit a project's water meter reading data manually. The Water Meter Data Entry page 1102 contains a Selection Tree 1106 in the left hand side of the page which is hierarchical in nature and provides a means of selecting which managed projects meter reading data will be entered into the application software. Within any unique Company instance of the application software, the highest level of the Selection Tree 1106 is the Company which has been granted access to the application and who is operating said unique instance. Any level of the Selection Tree 1106 may be highlighted by clicking on the Selection Tree level. Highlighting the highest level of the Selection Tree, or the Company level may direct the application software to list all of the water meters managed by the application software instance in the data entry table 1104 so that water meter data for each meter may be entered. If only a single project is highlighted in the Selection Tree 1106, then only the water meters associated with the highlighted project will be listed in the data entry table 1104. It is possible to select just one single project, or many different projects as desired.

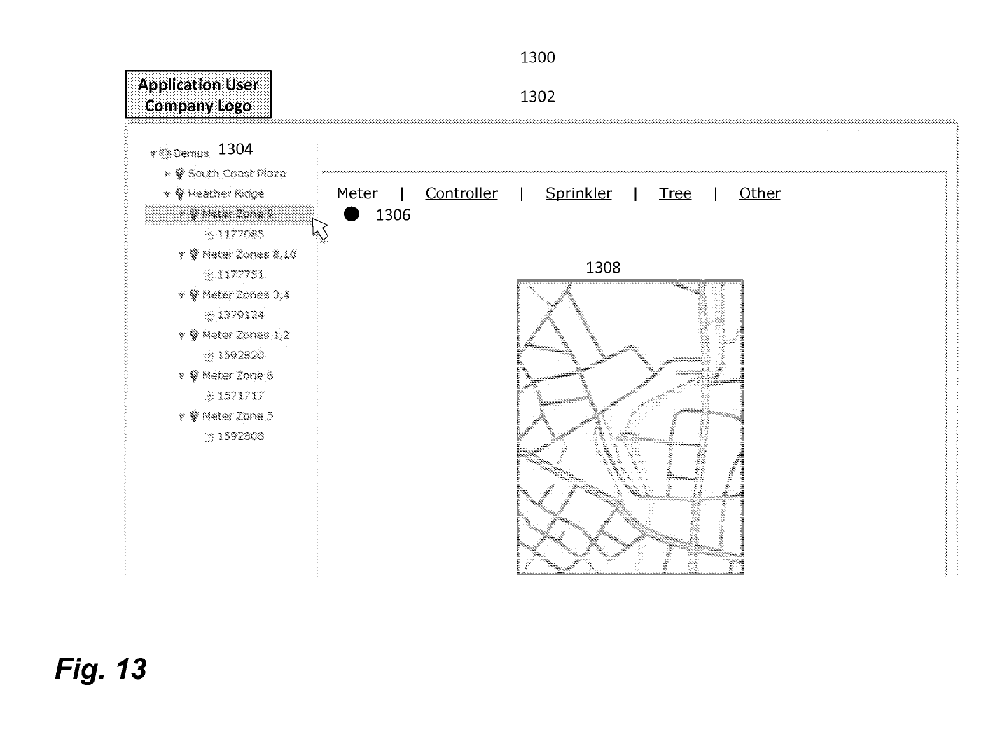

In additional reference to FIG. 11, The Data Entry Table 1104 is used by the user to enter water meter data into the application according to what has been selected in the Selection Tree 1106. The Data Entry Table 1104 contains eight columns which are labeled: 1) Project, 2) Meter Number, 3) Previous Read 4) New Read, 5) Usage (CCF), 6) Billing Variance, 7) Adjustment. The Meter Number column displays the Meter ID number as has been entered into the application's Meter Zones page for each water meter selected in the Selection Tree 1106. To the left of the Meter Number column is the Project column which displays the name of the Project in which each meter displayed in the Data Entry Table 1104 is located. To the right of the Meter Number column is the Previous Read column which displays the previous meter read value that was entered into the application for each meter in the Data Entry Table 1104. The purpose of showing the Previous Read value is so that the when by manual data entry, a person entering current meter read data will have a reference as an aid in avoiding data entry errors. To the right of the Previous Read column is the New Read column in which the application user may enter the most current water meter reading value, or edit past meter reading value entries. To the right of the New Read column is the Usage (CCF) column which displays the current water usage in hundreds of cubic feet, or CCF for the current water billing cycle and based on current and past meter reading values that have been entered. To the right of the Usage (CCF) column is the Billing Variance column which displays the water usage as a percentage of the current water budget within the current billing cycle as calculated by the application and is based on the water retailer which has been assigned to the project where the water meter is located and as selected in the application software's Project Information page. To the right of the Billing Variance column is the Adjustment column which displays a predictive value by which the irrigation system for the particular meter should be adjusted such that the irrigator will arrive at or below the irrigation budget at that meter before the end of the billing cycle. To enter water meter reading data into the application manually, the user first selects the projects which contain the meters whose readings will be entered by highlighting those projects in the Selection Tree 1106. Doing so will cause the application to list those meters as selected in the Selection Tree 1106 within the Data Entry Table 1104. The user then enters the date on which the meter reading values were obtained in the Read Date entry field above the table. The user then places the computer cursor in the Data Entry Table 1104 row of the meter number whose data is to be entered and in row's cell which is within the Meter Read column as depicted in FIG. 13. The user clicks the cell and then enters the meter read value. This process is performed over and over until all meter read data has been entered. The user then selects the Save button 1108 which causes the meter reading values which have been entered into the table to be saved to the application software. Selecting the Save button 1108 will also cause the application to perform the calculations whose solutions will populate the according cells within the Usage (CCF), Billing Variance, and Adjustment columns.

In further reference to FIG. 11, the following calculations are performed by the application to obtain the values which populate the Usage (CCF), Billing Variance, and Adjustment columns:

For each consecutive entry of meter read data within a water meter's New Read table cell, the usage which has occurred between the previous meter read and the new or current meter read date is determined through simple subtraction:

Usage (CCF)=[Previous Meter Read Value in CCF]−[New Meter Read Value in CCF]

Once a billing period to date water budget has been calculated by the application software for each water meter using the water budget calculation rules established according to the particular water district and as are present in the calculation engine's Water District Database, the application software may take the billing period to date water usage and perform for each meter separately and on an individual meter by meter basis the following calculation:

Meter Billing Variance=[Current Meter Billing Cycle Usage (CCF)/Current Meter Billing Cycle Water Budget (CCF)]×100.

The Adjustment calculation, or irrigation system adjustment index calculation used by the application software is water district specific and is based on the water district which has been assigned to each meter. The Adjustment calculation used by the application is also dependent on historical ETo. Accordingly, the application software may call on the water district database and the ETo database to calculate irrigation system adjustment index. The adjustment index is a predictive value calculated by the application software and produces a percentage value by which the irrigation system for any particular meter which is over budget should be adjusted downward such that the irrigation water consumed for the entire billing period will be below the irrigation budget for the billing cycle. Using a proprietary algorithm, the application software may consider historical ETo for each day remaining in the over budget meter's billing cycle, the current ETo trend, forecasted weather data, and the amount by which the meter is currently over budget. The adjustment index may be used to advantage by application users because the predictive value suggested by the adjustment index is a value which is based on the associated water retailer's water budget rules, and current and historical weather, and/or forecasted weather.

In further reference to FIG. 11, it should be appreciated that the foregoing description of data entry into the application is devoid of limiting data entry to a type of computer, i.e. desktop computer, tablet computer, or other mobile computing device. The reason for this is that the preferred embodiment of the application software is a cloud computing based format which, as has been previously stated, is accessible via the Internet, and therefore any computing device connected to the Internet and with access to the application may serve as a device through which water meter data may be entered into the application. In a second embodiment of the disclosure of FIG. 11, water meter data may be entered into the application via structured text message or e-mail which is sent directly to the application with sufficient information for the application to properly associate text messaged data with the proper application instance, the proper project within the proper application instance, and the proper meter ID, metering reading date, and meter reading value associated with the proper project and application instance. In a third embodiment of the disclosure of FIG. 11, water meter data may be entered into the application via a photograph of the water meter details including the meter reading, said photograph having been taken with the mobile computing device through which the structured text message or e-mail will be sent. The attached photograph of the meter and the meter's reading may have the necessary geo-positioning data embedded within the photograph data which would allow the application to automatically determine which meter the meter reading data is associated with. Furthermore, the application may employ character recognition techniques that would allow the application software to deduce the meter reading value from the photograph and thus save time and reduce errors associated with manual meter reading data collection and transmittal. In yet a fourth embodiment, data entry may be performed automatically when the application is permitted to interface with a water retailer's or water district's billing system software whereby historical water meter usage and water meter cost data may be queried and accessed directly by the application software so that historical water meter usage and water meter cost data may be automatically uploaded into the application software.

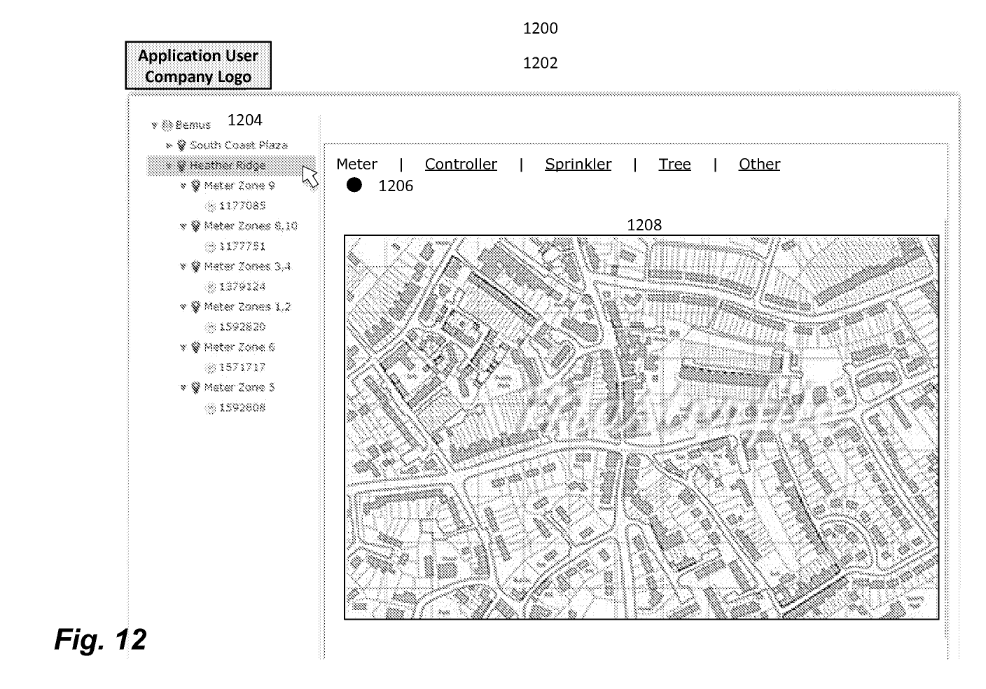

Referring to FIG. 12 a user interface 1200 rendering of the present disclosure's Map page 1202 in the project map view prior to mapping of landscape asset icons, or icons, is shown. The application software's Map page 1202 contains a Selection Tree 1204 in the left hand side of the page, a large window, or map viewing area 1208, which occupies most of the remainder of the page and which contains, depending on what has been selected in the Selection Tree 1204, either the project map image 1208 which has been uploaded into the application in the application's Project Information page, or a meter zone map image which is a subset of the project map and which has been edited and assigned to the corresponding project's meter zones in the application's Project Meter Zone Definition page. Above the map image but within the map viewing area are asset icon generation links for landscape assets, namely: Meter, Controller, Sprinkler, Tree, Other. Below the Meter icon generation link is a solid black circle 1206 which is an un-mapped meter icon, or water meter icon.

In further reference to FIG. 12, as previously stated, the map image 1208 present in the Map page's viewing area is dependent on what has been selected in the Selection Tree 1204. FIG. 12 depicts the project map view 1208 because a project (Heather Ridge) has been selected in the Selection Tree 1204. Additionally, the application software's icon generation links within the map viewing area are used to generate a variety of icons which may be placed onto the map via a drag and drop process (mapping). The present example of icon generation links is not meant to depict an exhaustive list of icon generating links which may be employed and thus the application is not limited to employing only these icons and icon generation links as depicted. The present example is used to demonstrate how icons of any useful sort for landscape irrigation management or landscape management or property management in general may be generated within the application software, and how the application software's icons may be mapped and used to advantage for landscape management or property management purposes within the application.

Referring to FIG. 13, a second user interface 1300 rendering of the present disclosure's Map page 1302 is shown, but now in the meter zone map 1308 view prior to mapping of icons. FIG. 13 depicts the meter zone map view 1308 because a meter zone (meter zone 9) has been selected in the Selection Tree 1304. Accordingly, FIG. 13 depicts the Selection Tree 1304 and Map Viewing Area 1308 which contains the same icon generation links and meter icon 1306 as depicted and previously described in FIG. 12.

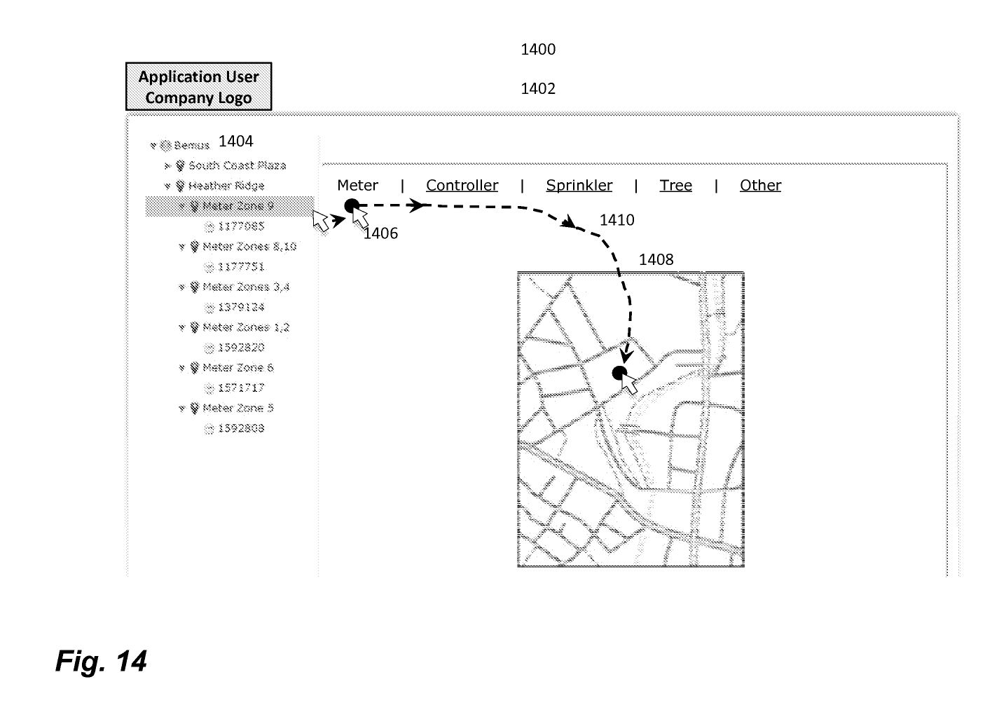

Referring to FIG. 14, a second user interface 1400 rendering of the present disclosure's Map page 1402 in the meter zone map view 1408 is shown, but now with a depiction of the icon 1406 drag and drop process (mapping) 1410. In addition to the same icon generation links and meter icon as depicted and previously described in FIG. 12, there is a dotted line 1410 which appears only as an aid in depicting the drag and drop process of mapping of the meter icon and therefore the dotted line as depicted is not actually present in the application software's user interface 1400.

In further reference to FIG. 14, within the application software's Map page 1402, the mapping process for water meter icons is as follows:

1) Select the desired map view in the Selection Tree 1404, i.e. either the project view, or the meter zone view. This will bring the appropriate map into the map viewing area 1408. If, there remain any meter zones which have been defined in the application software's Meter Zone Definition page that have not been mapped, then a meter icon 1406 may be present underneath the meter icon generation link. As depicted in FIG. 14, Meter Zone 9 has been selected in the Selection Tree 1404, and the Meter Zone 9 map appears in the map viewing area 1408. Also depicted is a meter icon 1406 underneath the meter icon generation link indicating that the meter icon 1406 for Meter Zone 9 has yet to be mapped.

2) Using a computer mouse, the mouse cursor is moved to Meter Zone 9's meter icon.

3) Meter Zone 9's meter icon is clicked upon with the computer mouse, but not released, and the mouse is then used to drag the meter icon to the map image and the meter icon is situated in the location on the map which is representative of the real meter's actual physical location.

4) The cursor is then released, or dropped, by releasing the mouse button which was used in step 3 above to click the icon. This completes the icon mapping process.

In additional reference to FIG. 14, it should be appreciated that when GPS coordinates for objects such as water meters has been included as part of the information to be entered in the application's Project Meter Zones page, and when the project maps and meter zone maps contain GPS data, the application software is also capable of mapping icons based on GPS coordinate data.

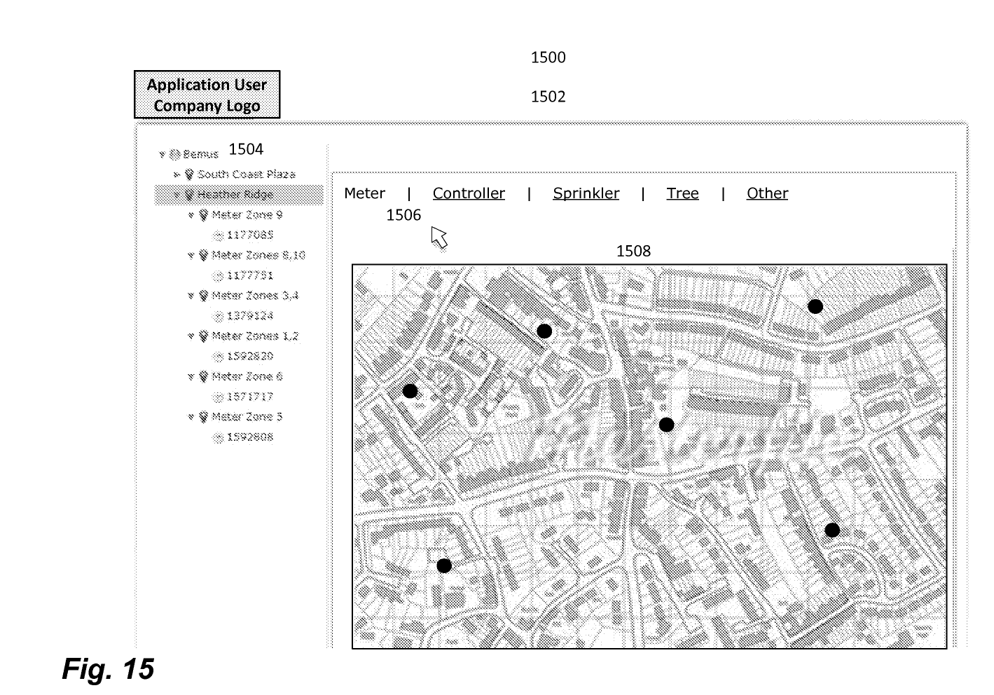

Referring to FIG. 15, a second user interface 1500 rendering of the present disclosure's Map page 1502 in the project map view 1508 is shown, but now with all project water meter icons having been mapped. Depicted are the Selection Tree 1504 in the left hand side of the page and the map viewing area. Above the map image but within the map viewing area 1508 are icon generation links, namely: Meter, Controller, Sprinkler, Tree, Other 1506. The project map now contains six mapped meter icons which correspond to the six meters as have been defined for the project selected in the application software's Selection Tree 1504.

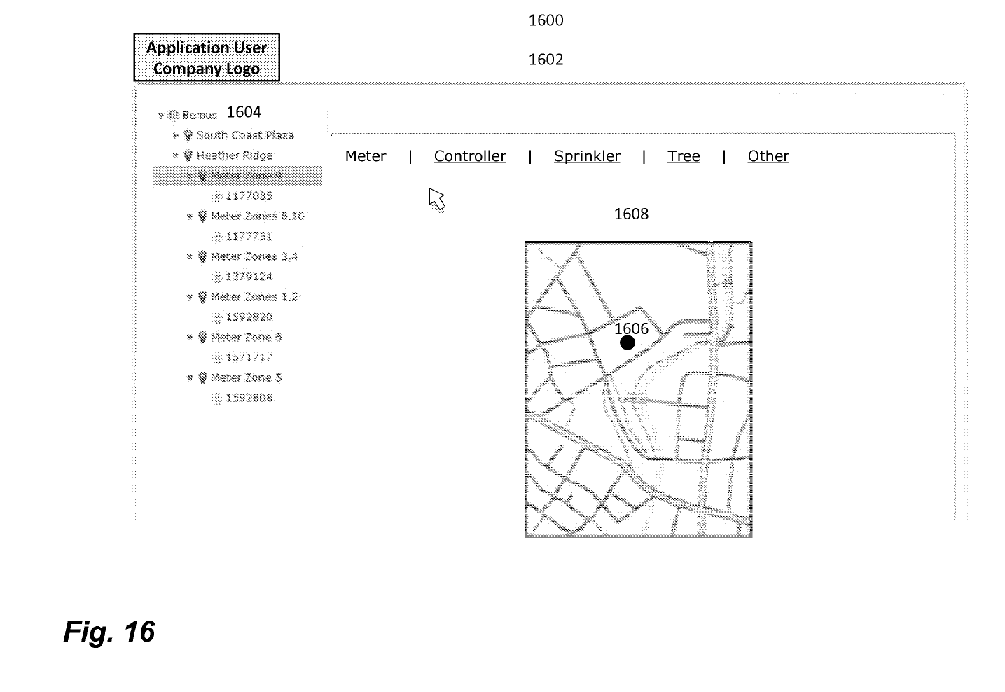

Referring to FIG. 16, a third user interface 1600 rendering of the present disclosure's Map page 1602 in the meter zone map view is shown, but now with the meter zone's water meter icon 1606 having been mapped. Accordingly, FIG. 16 depicts the Selection Tree 1604 and Map Viewing Area 1608 which contains the same icon generation links and meter icon as depicted and previously described in FIG. 12. Also depicted within the Map Viewing area 1608 is the map associated with Meter Zone 9 as selected in the Selection Tree 1604. The meter zone map 1608 exhibits a meter icon 1606 which has been mapped.

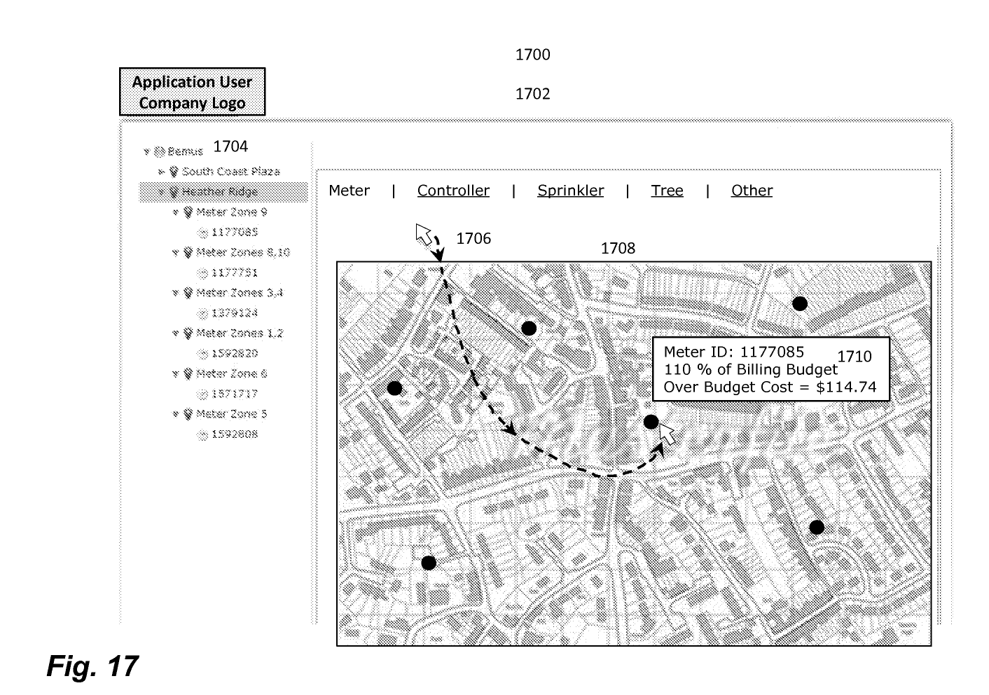

Referring to FIG. 17, a third user interface 1700 rendering of the present disclosure's Map page 1700 in the project map view 1708 is shown, but now demonstrating how rolling a computer mouse cursor over a mapped water meter icon may cause the user interface to present additional information about the water meter represented by the mapped icon 1706. Depicted are the Selection Tree 1704 in the left hand side of the page and the map viewing area 1708. Above the map image but within the map viewing area 1708 are icon generation links. The project map 1708 now contains six mapped meter icons which correspond to the six meters as have been defined for the project selected in the application software's Selection Tree 1704. Also depicted is a dotted line which appears in FIG. 17 only as an aid in depicting how a computer mouse's cursor may be positioned over a mapped meter icon to cause the application software to display a pop-up text box 1710, which is also depicted in FIG. 17.

In further reference to FIG. 17, within the application software's Map page 1702, the application may be caused to display a pop-up text box which contains additional information about mapped meter icons such as is depicted in FIG. 17. This is accomplished by the user as follows:

1) Select the desired map view in the Selection Tree 1704, i.e. either the project view, or the meter zone view. This will bring the appropriate map into the map viewing area 1708. As depicted in FIG. 17, the Heather Ridge project has been selected in the Selection Tree 1704, and the Heather Ridge project map appears in the map viewing area. Also depicted are the project's six meter icons which have been mapped.

2) Using a computer mouse, the mouse cursor is moved to any meter icon present on the project map 1706. As an example, FIG. 17 depicts the computer cursor having been moved to a hovering position over Meter ID 1177085. As depicted in FIG. 17, this has caused a text box 1710 to appear above Meter ID 1177085's icon which contains the meter's ID number (1177085), the current billing cycle water usage (110%), and the present Over Budget Cost ($114.74). The pop-up box 1710 is not limited to displaying only the depicted information and has been presented in FIG. 17 as an example of how current information relevant to irrigated water usage and cost may be presented to the user from within the application software's project map view 1708.

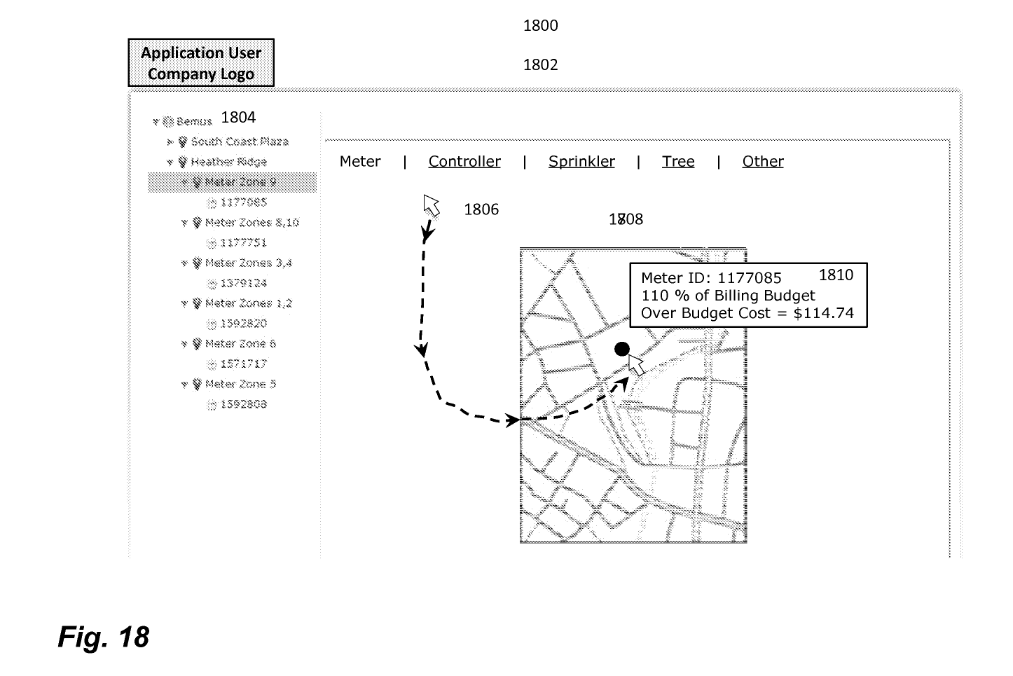

Referring to FIG. 18, a fourth user interface 1800 rendering of the present disclosure's Map page 1802 in the meter zone map view 1808 is shown, but now demonstrating how rolling a computer mouse pointer over a mapped water meter icon may cause the user interface to present additional information about the water meter represented by the mapped icon 1806. Depicted are the Selection Tree 1804 in the left hand side of the page and the map viewing area 1808. Above the map image 180-8 but within the map viewing area are icon generation links. The meter zone map 1808 now contains a single mapped meter icon which corresponds to the meter as has been defined for the meter zone selected in the application software's Selection Tree 1804. Also depicted is a dotted line 1806 which appears only as an aid in depicting how a computer mouse's cursor may be positioned over a mapped meter icon to cause the application software to display a pop-up text box, which is also depicted in FIG. 18. As in the project map view 1808, to cause the application software to display the depicted text box 1810, the following process is followed:

1) Select the desired map view in the Selection Tree 1804, i.e. either the project view, or the meter zone view. This will bring the appropriate map into the map viewing area. As depicted in FIG. 18, Meter Zone 9 within the Heather Ridge project has been selected in the Selection Tree 1804, and the Meter Zone 9 meter zone map appears in the map viewing area. Also depicted is the meter zone's single meter icon which has been mapped 1806.

2) Using a computer mouse, the mouse cursor is moved to the meter icon present on the meter zone map. As an example, FIG. 18 depicts the computer cursor having been moved to a hovering position over Meter ID 1177085. As depicted in FIG. 18, this has caused a text box 1810 to appear above Meter ID 1177085's icon which contains the meter's ID number (1177085), the current billing cycle water usage (110%), and the present Over Budget Cost ($114.74). The pop-up box 1810 is not limited to displaying only the depicted information and has been presented in FIG. 18 as an example of how current information relevant to irrigated water usage and cost may be presented to the user from within the application software's meter zone map view 1808.

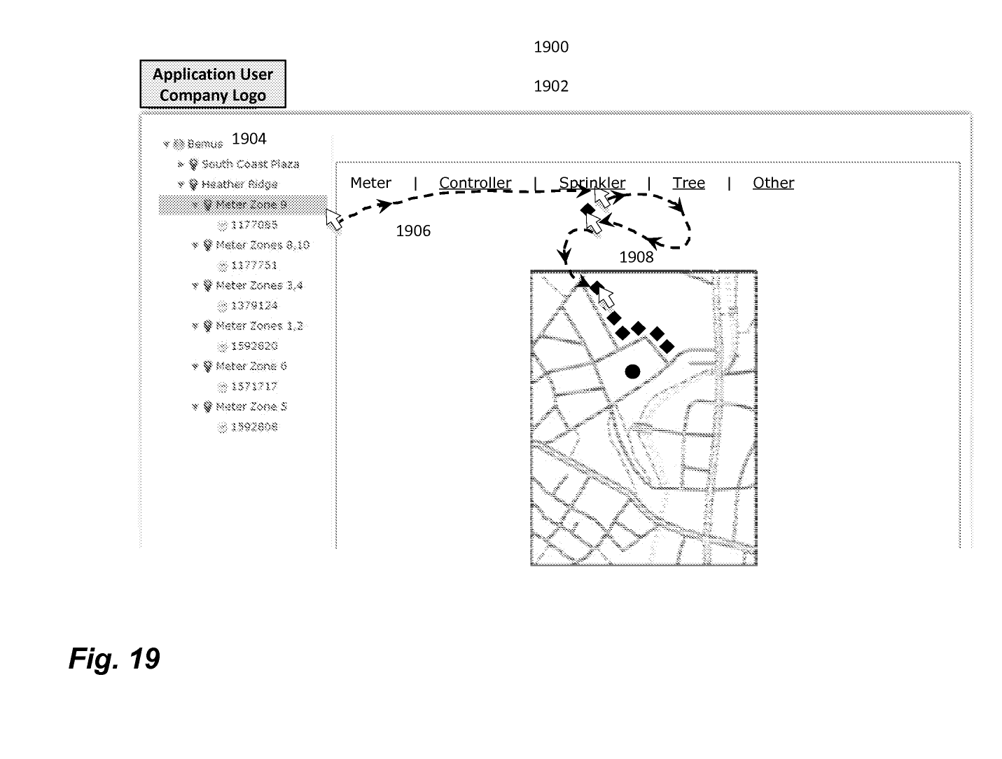

Referring to FIG. 19, a fifth user interface 1900 rendering of the present disclosure's Map page 1902 in the meter zone map view is shown, but now demonstrating the icon generation and mapping process for additional high value landscape plant materials such as trees. In addition to the same icon generation links as depicted and previously described in FIG. 12, there is a dotted line 1906 which appears only as an aid in depicting the icon generation and mapping process of tree icons and therefore the dotted line as depicted is not actually present in the application's user interface. Additionally, the Meter Zone 9 meter map is present in the page's Map Viewing area 1908. The Meter Zone 9 meter map displays the single black water meter icon which has previously been mapped, and also displays five black diamond icons which are the tree icons which have previously been mapped, and a sixth tree icon which is in the process of being mapped, the process for which follows.

In further reference to FIG. 19, within the application software's Map page, the mapping process for tree icons is as follows:

1) Select the desired map view in the Selection Tree 1904, i.e. either the project view, or the meter zone view. This will bring the appropriate map into the map viewing area 1908. As depicted in FIG. 19, Meter Zone 9 has been selected in the Selection Tree 1904, and the Meter Zone 9 map appears in the map viewing area 1900.

2) If the user desires to map trees within Meter Zone 9, the user should take notice of the Tree icon generation link in the Map Viewing 1908 area where the Meter Zone 9 map is displayed. If the Tree icon generation link is available, then this is an indication to the user by the application that there remain trees which have been defined in the Meter Zone Definition page for Meter Zone 9 that have yet to be mapped. Conversely, if all trees within Meter Zone 9 had already been mapped, the Tree icon generation link would still be visible to the user, but grayed out, and thus unavailable for generating tree icons.

3) Using the computer mouse, the mouse cursor is moved to the Tree icon generation link, and Meter Zone 9's available Tree icon generation link is clicked upon with the computer mouse.

4) Clicking the available Tree icon generation link will cause the application software to generate a tree icon directly below the Tree icon generation link as depicted in FIG. 19 where the black diamond underneath the Tree icon generation link represents a newly generated Tree icon.

5) The computer cursor is then moved to a hovering position over the tree icon, and the tree icon is clicked upon with the computer mouse, but not released, and the mouse is then used to drag the tree icon to the map image where the tree icon is situated in the location on the map which is representative of the real tree's actual physical location.

6) The cursor is then released, or dropped, by releasing the mouse button which was used in step 5 above to click the icon. This completes the tree icon generation and mapping process.

In additional reference to FIG. 19, it should be appreciated that when GPS coordinates for high value landscape plant materials or other objects such as trees has been included as part of the information to be entered in the application software's Project Meter Zones page, and when the project maps and meter zone maps contain GPS data, the application software is also capable of mapping icons based on GPS coordinate data. It should also be appreciated that the application software is not limited to icon generation and mapping of only plant materials such as trees and such as has been described, but rather that the application software is flexible and can be configured to accommodate icon generation and mapping of a variety of objects of any useful sort for landscape irrigation management purposes or landscape management or property management purposes in general, and how icon generation and mapping may be used to advantage for landscape management or property management purposes within the application.

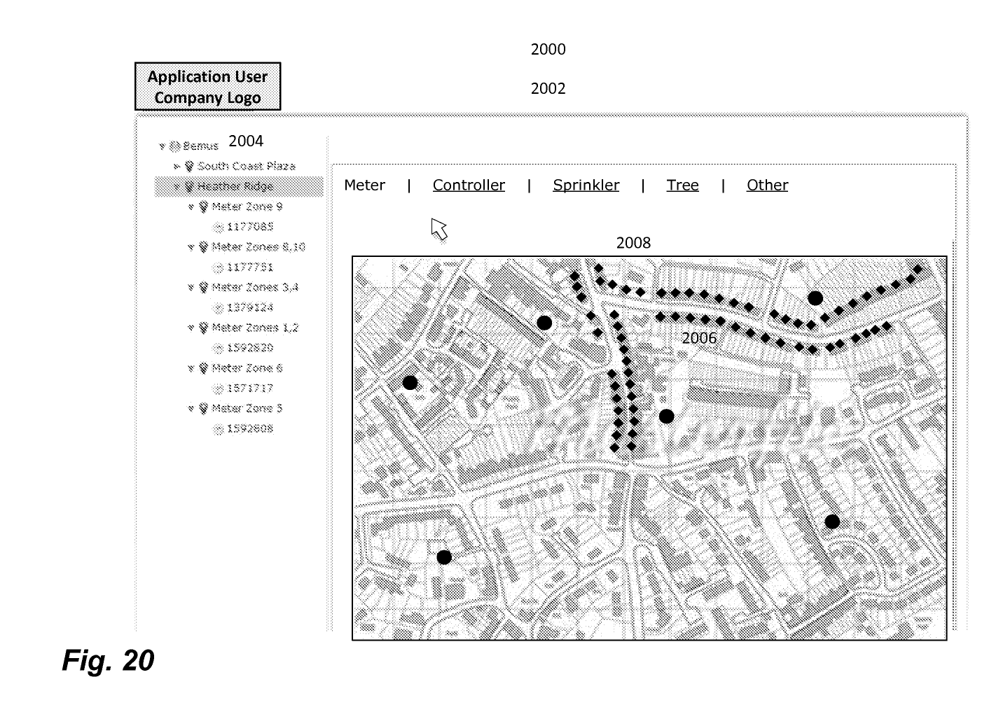

Referring to FIG. 20, a fourth user interface 2000 rendering of the present disclosure's Map page 2002 in the project map view is shown, but now after both water meter icons and landscape object icons, such as tree icons have been mapped 2006. Depicted are the Selection Tree 2004 in the left hand side of the page and the map viewing area. Above the project map image 2008 but within the map viewing area are icon generation links. The project map 2008 now contains six mapped water meter icons which correspond to the six meters as have been defined for the project selected in the application's Selection Tree 2004. Also depicted as having been mapped are many black diamond icons, or tree icons, which correspond to trees which have been defined for the project selected in the application's Selection Tree 2004.

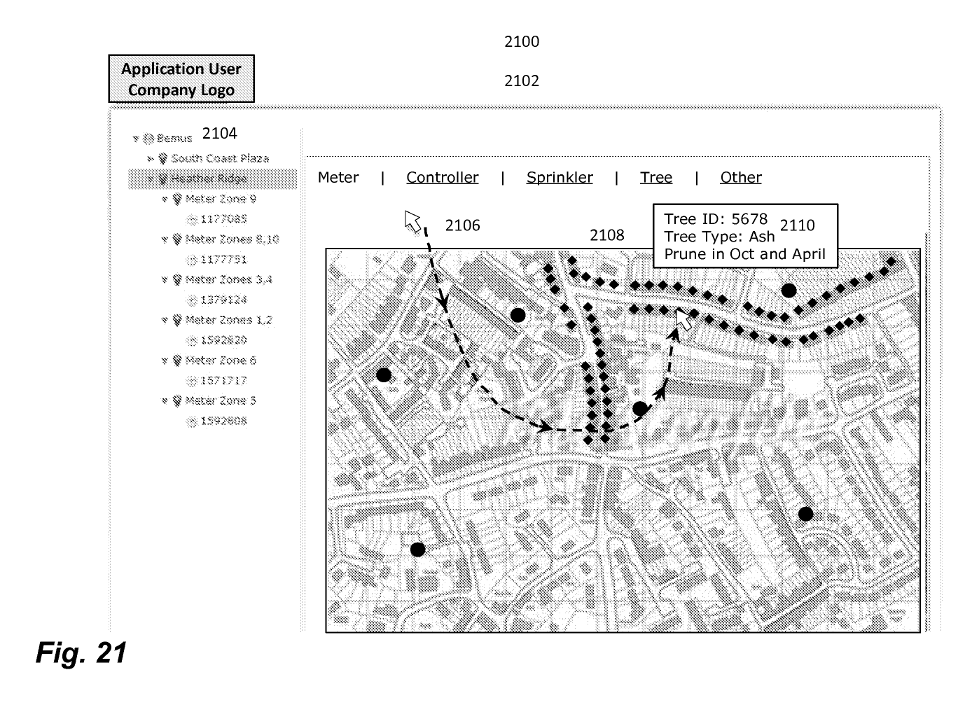

Referring to FIG. 21, a fifth user interface 2100 rendering of the present disclosure's Map page 2102 in the project map view is shown, but now demonstrating how rolling a computer mouse cursor over a mapped landscape icon 2106 may cause the user interface to present additional information about the landscape object represented by the mapped icon. Depicted are the Selection Tree 2104 in the left hand side of the page and the map viewing area 2108. Above the map image 2108 but within the map viewing area are icon generation links. The project map 2108 now contains six mapped meter icons which correspond to the six meters as have been defined for the project selected in the application's Selection Tree 2104. Also depicted as having been mapped are many black diamond icons, or tree icons, which correspond to trees which have been defined for the project selected in the application's Selection Tree. Also depicted is a dotted line 2106 which appears in FIG. 21 only as an aid in depicting how a computer mouse's cursor may be positioned over a mapped landscape object icon, and in this example a tree icon, to cause the application to display a pop-up text box 2110, which is also depicted in FIG. 21.

In further reference to FIG. 21, within the application's Map page 2102, the application software may be caused to display a pop-up text box 2110 which contains additional information about mapped landscape icons such as tree icons and such as is depicted in FIG. 21. This is accomplished by the user as follows:

1) Select the desired map view in the Selection Tree 2104, i.e. either the project view, or the meter zone view. This will bring the appropriate map into the map viewing area 2108. As depicted in FIG. 21, the Heather Ridge project has been selected in the Selection Tree 2104, and the Heather Ridge project map appears in the map viewing area. Also depicted are the project's six meter icons which have been mapped, and the many tree icons which have been mapped.

2) Using a computer mouse, the mouse cursor is moved to any tree icon present on the project map 2108. As an example, FIG. 21 depicts the computer cursor having been moved to a hovering position over Tree ID 5678. As depicted in FIG. 21, this has caused a text box 2110 to appear above Tree ID 5678's icon which contains the tree's ID number (5678), the tree type (Ash), and the tree's maintenance schedule (Prune in October and April). The pop-up box 2110 is not limited to displaying only the depicted information and has been presented in FIG. 21 as an example of how current information relevant to landscape objects that have been mapped within the application may be presented to the user from within the application's project map view.

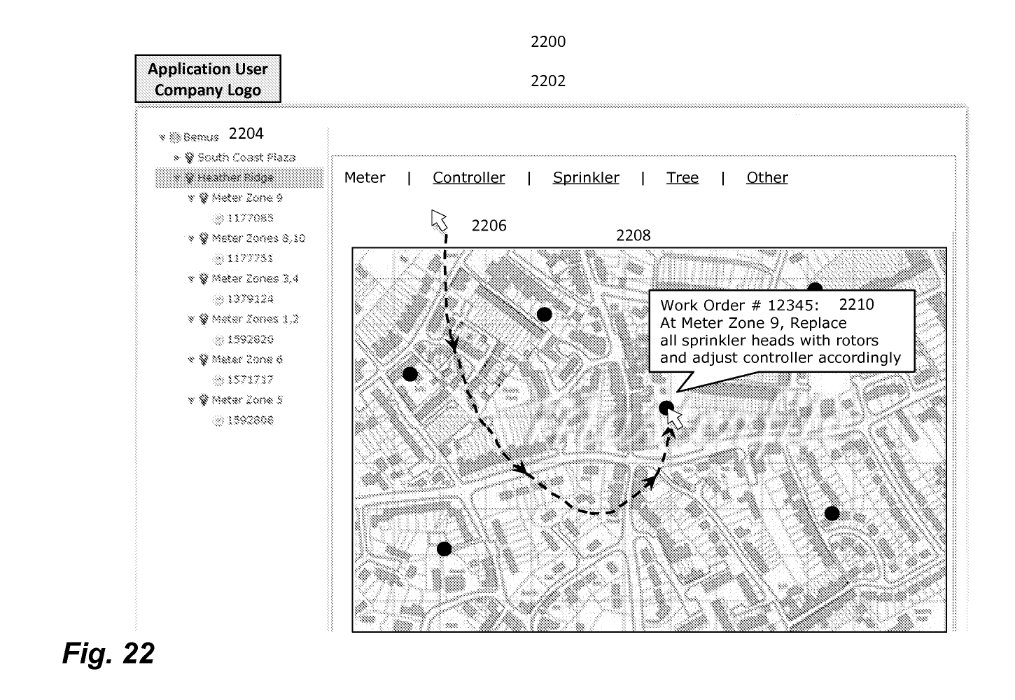

Referring to FIG. 22, a sixth user interface 2200 rendering of the present disclosure's Map page 2202 in the project map view 2208 is shown, but now demonstrating how users may annotate the Project Map page with additional information such as work order information. Depicted are the Selection Tree 2204 in the left hand side of the page and the map viewing area 2208. Above the map image 2208 but within the map viewing area are icon generation links. The project map now contains six mapped meter icons which correspond to the six meters as have been defined for the project selected in the application software's Selection Tree 2204. Also depicted is a dotted line 2206 which appears in FIG. 22 only as an aid in depicting how a computer mouse's cursor may be positioned over a mapped meter icon and double clicked to cause the application to display a pop-up text box 2210, which is also depicted in FIG. 22.

In further reference to FIG. 22, within the application software's Map page 2202, the application software may be caused to display an empty pop-up text box 2210 which may be used by the user to annotate a map such as is depicted in FIG. 22 after annotation. This is accomplished by the user as follows:

1) Select the desired map view in the Selection Tree 2204, i.e. either the project view, or the meter zone view. This will bring the appropriate map into the map viewing area 2208. As depicted in FIG. 22, the Heather Ridge project has been selected in the Selection Tree 2204, and the Heather Ridge project map appears in the map viewing area 2208. Also depicted are the project's six meter icons which have been mapped.

2) Using a computer mouse, the mouse cursor is moved to any meter icon present on the project map. As an example, FIG. 22 depicts the computer cursor having been moved to a hovering position over Meter ID 1177085, or Meter Zone 9.

3) Next, the user double clicks the meter icon, and as depicted in FIG. 22, this has caused a text box 2210 to appear above Meter ID 1177085's icon in which the user has entered a work order (work order #12345) and accompanying work order instructions (Replace all sprinkler heads with rotors, and adjust controller accordingly). This example demonstrates a useful way for any one application user to communicate to other users of the cloud computing based application software anything that may be relevant to irrigation management or landscape or property management in general.

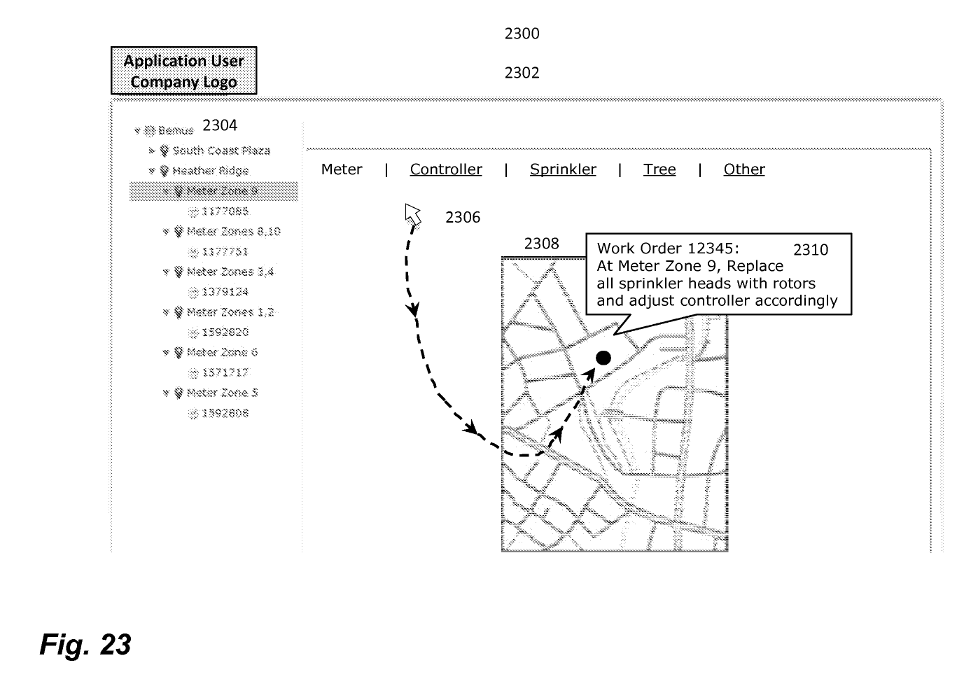

Referring to FIG. 23, a seventh user interface 2300 rendering of the present disclosure's Map page 2302 in the meter zone map view is shown, but now demonstrating how users may annotate the Project Meter Zone Map page with additional information such as work order information. Depicted are the Selection Tree 2304 in the left hand side of the page and the map viewing area 2308. Above the map image but within the map viewing area are icon generation links. The meter zone map now contains a single mapped meter icon which corresponds to the meter as has been defined for the meter zone selected in the application software's Selection Tree 2304. Also depicted is a dotted line which appears in FIG. 23 only as an aid in depicting how a computer mouse's cursor may be positioned 2306 over a mapped meter icon and double clicked to cause the application to display a pop-up text box 2310, which is also depicted in FIG. 23. As in the project map view, to cause the application software to display the depicted text box 2310, the following process is followed:

1) Select the desired map view in the Selection Tree 2304, i.e. either the project view, or the meter zone view. This will bring the appropriate map into the map viewing area 2308. As depicted in FIG. 23, the Heather Ridge project has been selected in the Selection Tree 2304, and the Heather Ridge project map appears in the map viewing area 2308. Also depicted are the project's six meter icons which have been mapped.

2) Using a computer mouse, the mouse cursor is moved to any meter icon present on the project map. As an example, FIG. 23 depicts the computer cursor having been moved to a hovering position over Meter ID 1177085, or Meter Zone 9.

3) Next, the user double clicks the meter icon, and as depicted in FIG. 22, this has caused a text box 2310 to appear above Meter ID 1177085's icon in which the user has entered a work order (work order #12345) and accompanying work order instructions (Replace all sprinkler heads with rotors, and adjust controller accordingly).

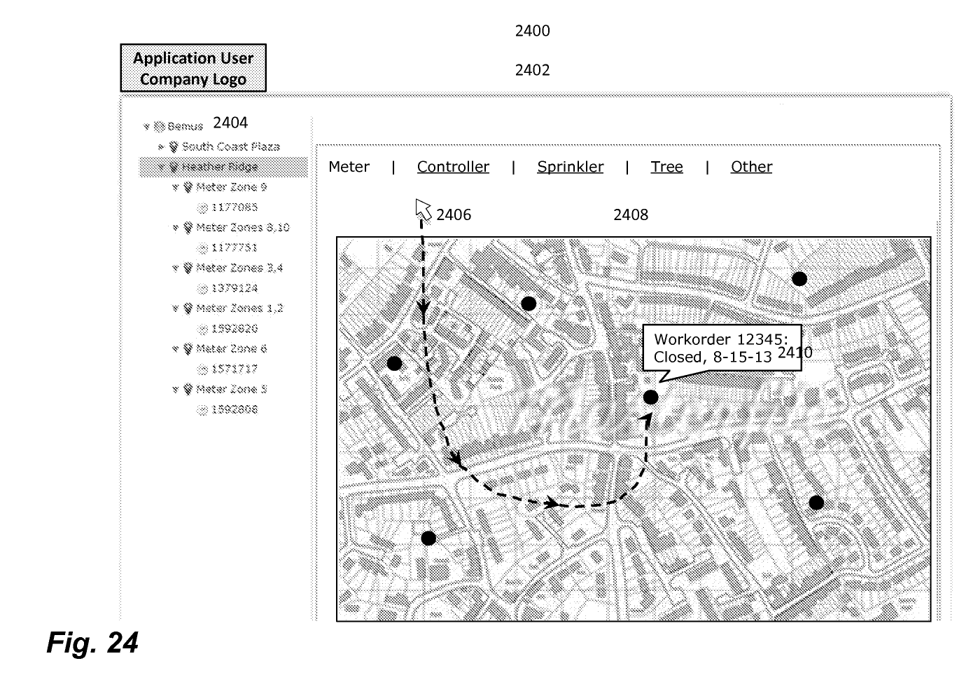

Referring to FIG. 24, an eighth user interface 2400 rendering of the present disclosure's Map page 2402 in the project map view 2408 is shown, but now demonstrating how information may be exchanged between users of the present disclosure by using annotations. Depicted are the Selection Tree 2404 in the left hand side of the page and the map viewing area 2408. Above the map image but within the map viewing area are icon generation links. The project map now contains six mapped meter icons which correspond to the six meters as have been defined for the project selected in the application software's Selection Tree 2404. Also depicted is a dotted line 2406 which appears in FIG. 24 only as an aid in depicting how a computer mouse's cursor may be positioned over a mapped meter icon and double clicked to cause the application software to display a pop-up text box 2410, which is also depicted in FIG. 24.

In further reference to FIG. 24, within the application software's Map page, the application software may be caused to display an empty pop-up text box 2410 which may be used by the user to annotate a map such as is depicted in FIG. 24 after annotation. This is accomplished by the user as follows:

1) Select the desired map view in the Selection Tree 2404, i.e. either the project view, or the meter zone view. This will bring the appropriate map into the map viewing area 2408. As depicted in FIG. 24, the Heather Ridge project has been selected in the Selection Tree 2404, and the Heather Ridge project map appears in the map viewing area 2408. Also depicted are the project's six meter icons which have been mapped.

2) Using a computer mouse, the mouse cursor is moved to any meter icon present on the project map. As an example, FIG. 24 depicts the computer cursor having been moved to a hovering position over Meter ID 1177085, or Meter Zone 9.

3) Next, the user double clicks the meter icon, and as depicted in FIG. 22, this has caused a text box 2410 to appear above Meter ID 1177085's icon in which the user has entered text indicating that a work order (work order #12345) is now closed, and the date the work order was closed (Aug. 15, 2013). This example demonstrates yet another useful way for any one application user to communicate to other users of the cloud computing based application anything that may be relevant to irrigation management or landscape management or property management in general.

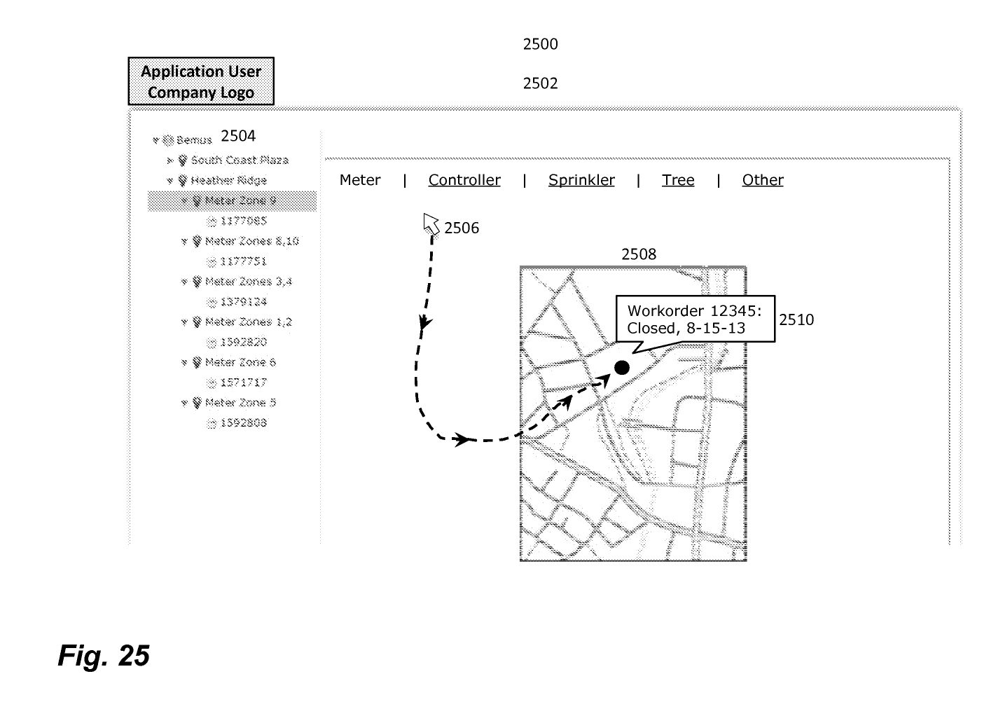

Referring to FIG. 25, a ninth user interface 2500 rendering of the present disclosure's Map page 2502 in the meter zone map view is shown, but now demonstrating how information may be exchanged between users of the present disclosure by using annotations. Depicted are the Selection Tree 2504 in the left hand side of the page and the map viewing area 2508. Above the map image but within the map viewing area are icon generation links. The meter zone map now contains a single mapped meter icon which corresponds to the meter as has been defined for the meter zone selected in the application's Selection Tree 2504. Also depicted is a dotted line which appears in FIG. 25 only as an aid in depicting how a computer mouse's cursor may be positioned 2506 over a mapped meter icon and double clicked to cause the application software to display a pop-up text box 2510, which is also depicted in FIG. 25. As in the project map view, to cause the application software to display the depicted text box, the following process is followed:

1) Select the desired map view in the Selection Tree 2504, i.e. either the project view, or the meter zone view. This will bring the appropriate map into the map viewing area 2508. As depicted in FIG. 25, the Heather Ridge project has been selected in the Selection Tree 2504, and the Heather Ridge project map appears in the map viewing area 2508. Also depicted are the project's six meter icons which have been mapped.

2) Using a computer mouse, the mouse cursor is moved to any meter icon present on the project map. As an example, FIG. 25 depicts the computer cursor having been moved to a hovering position over Meter ID 1177085, or Meter Zone 9.

3) Next, the user double clicks the meter icon, and as depicted in FIG. 24, this has caused a text box 2510 to appear above Meter ID 1177085's icon in which the user has entered text indicating that a work order (work order #12345) is now closed, and the date the work order was closed (Aug. 15, 2013).

The advantages of the present disclosure include, without limitation, a cloud computing based irrigation billing cycle budget software application with predictive irrigation system adjustment index output capability which consolidates a multitude of disparate water budget calculations, water retailer billing cycles and pricing structures, irrigated landscape data, and historical and current weather data and which provides irrigators with an advantageous method for improved landscape irrigation management, and improved landscape management in general.

The preferred embodiment of the present disclosure is that the web-based application software with the irrigation billing cycle budget calculation engine with predictive irrigation system adjustment index calculation is that the disclosure operates on a cloud computing platform which is accessible via the Internet. This embodiment of the disclosure has many advantages including software application operational speed, the built in application robustness and redundancy characteristic of cloud computing based platforms and the scalability of the application as the number of users, and therefore number of managed landscapes grows. Some of the more practical advantages of the application's cloud-based nature also include the increased operating efficiency with which professional landscape companies and their irrigators are able to benefit from via use of the application. For example and as has been previously described, current budget based irrigation management practices often require twenty four to seventy two hours for the process to be executed and before irrigation system adjustments can be made. The lengthy execution cycle of current budget based irrigation management practices is due in large part to the manual data collection and entry of water meter data, data analysis, and the distribution of irrigation water consumption status to irrigators who must return to the numerous landscapes which they manage, determine if and how irrigation systems should be adjusted, and then perform the adjustment. Because the present disclosure operates on a cloud computing platform which is accessible via the Internet, the data entry required by the application is not limited to the type of data entry device which must be used, i.e. desktop computer, tablet computer, or other mobile computing device. More importantly, data entry is not limited to a specific location where data entry occurs and therefore, the current disclosure in preferred embodiment provides the clear advantage of allowing irrigators who use mobile computing devices to access in the field the application, perform data entry, analyze results, and make irrigation system adjustments all within a relatively short period of time and without having to make a second trip to each landscape to perform irrigation system adjustment. The reason for this is that the preferred embodiment of the application software is a cloud computing based format which, as has been previously stated, is accessible via the Internet, and therefore any computing device connected to the Internet and with access to the application may serve as a device through which water meter data, or any other data related to landscape management, may be entered into the application. Another practical advantage afforded by the present disclosure in preferred embodiment is that the cloud computing based nature of the application and Internet accessibility of the application provide any number of irrigation management and landscape management stakeholders, for example homeowner's association managers, property managers, and property management companies, to view and use the application thus engaging more stakeholders in the landscape management process.

An additional advantage of the present disclosure is the software application's ability to not only perform Irrigation budget calculations, but to perform Irrigation budget calculations which consider water cost in addition to just water volume. As has been previously stated, current weather-based water budget management processes involve the collecting of water volume usage and determining whether current usage volume is below, at or above budget. While consumed water volume is important, the overall cost of the consumed irrigation water is just as, if not more important than the consumed water volume. While water usage by volume is directly addressed, assessed and managed in current irrigation budget management processes which utilize weekly water meter reading to determine weekly water usage, the cumulative weekly cost of irrigation water is typically ignored. While some irrigation management practices may include the review of water bills to understand past monthly or bi-monthly water costs, this approach is inadequate as a management practice because it does not offer an opportunity to manage or control water costs during and throughout the billing cycle, and before excess water costs have already been incurred. Further, and on a water district by water district basis across the US, the implementation of tiered water rate structures is making weekly cumulative water cost extremely difficult to infer and cumbersome to calculate based on weekly cumulative water consumption alone. The reason for this is that within a tiered rate structure there is no uniform volumetric water rate, i.e. water volume consumed, and water cost are not linearly related. Because the present disclosure utilizes the water retailer's water budget calculation, water prices, water price structure, and water billing cycle begin and end dates in its calculations, the application has the practical advantage of returning actual water consumption performance as evaluated against the water budget in terms of both water volume and water cost. The result is that users of the present disclosure have more real-time visibility into the financial cost of landscape irrigation management resources whereas heretofore they have had none. The benefit of increased visibility of irrigation water costs during and throughout a billing cycle is even more advantageous in those areas where budget based tiered water pricing imposes severe financial penalties for exceeding the water district's imposed water budget, and as more and more water districts adopt budget based tiered pricing structures, the advantage of this benefit will increase.

As has been described, the present disclosure is advantageous and an improvement over current irrigation budget based landscape management methods and practices due to its ability to also consider the water retailer's water budget calculation, water price, price structure, and billing cycle begin and end dates when calculating actual water usage compared to the water retailer's irrigation budget, however one must also consider the complexity of performing such calculations in order to assess the current water usage compared to budget for many different managed landscapes across many different water districts when each of which will likely have different water prices, different water pricing structures, and different calculation methods for determining water budgets.

An emphasis, therefore, must be placed on the present disclosure's advantage with regard to its ability to reduce landscape management complexity by providing professional landscape companies with a simple and unencumbered method of quickly and easily performing the many disparate water budget calculations across the landscape company's many managed landscapes, and assessing the current actual water usage as compared to the budgeted usage, and to do so efficiently on an ongoing basis.

Yet another advantage of the present disclosure is that the irrigation billing cycle budget calculation engine with predictive irrigation system adjustment index calculation capability employed by the application software is able to provide irrigators with weather-based, as well as financially advantageous guidance with regard to irrigation system adjustment. As has been previously stated, irrigators are constantly faced with competing objectives with regard to landscape irrigation management and overall landscape appearance. To satisfy these competing objectives properly, the irrigator must consider several factors including current actual landscape meter water consumption against the water meter's weather-based irrigation budget, water billing cycle end date, cumulative water cost within the billing cycle and within the tiered rate structure if applicable, time of year, and the probable weather-based irrigation requirements between the present day and the end of the billing cycle which may be forecast based on history. It should be appreciated that the last consideration presented above, i.e. the probable weather-based irrigation requirements between the current day, wherever the current day may fall within the billing cycle, and the end of the billing cycle are dynamic, and as a reference, can change as much as 40% within a single thirty day billing cycle, or billing period. The challenge is clear as well as complex, a water meter's irrigation system adjustment within the context and framework of weather-based irrigation budgets and tiered cost structures is complex with many variables and considerations, and current weather-based irrigation budget landscape management practices have heretofore not had the mitigation strategy which is provided by the present disclosure's predictive irrigation system adjustment index calculation capability which takes into consideration all aforementioned factors and constraints.

Still yet another advantage of the present disclosure is that the application software platform defined by the present disclosure is a platform upon which further landscape management tools such as the application software's ability to allow the defining and mapping of managed landscapes so that not only the location of water meters within a landscape may be mapped and presented in the application's user interface, but also the defining and mapping of any other landscape objects which are relevant to landscape irrigation management and landscape management in general. For example, the mapping of water meter locations provides irrigators with a readily available reference map for each landscape under their management. Furthermore, the present disclosure's landscape map views with active water meter icons provide a method of observing current irrigation performance at each mapped meter and as related to the physical landscape itself, and as such provides heretofore unavailable information regarding the relationship of water meters, and thus irrigation system water consumption with respect to landscape physical properties and conditions. Equally important, the application software may be configured such that any number of landscape objects may be defined and mapped within the application such as the defining of trees and other objects deemed important by the application users. And as a related example of how the application software platform established by the present disclosure may be used to advantage, the application's user interface can be annotated by software users such that the communication of important information may be entered and observed within an application map view so that the important information such as work orders or work requests can be observed within the context of the physical landscape.

In broad embodiment, the present disclosure is landscape management application software which utilizes an irrigation billing cycle budget calculation engine with predictive irrigation system adjustment index calculation capability. For the purposes of landscape irrigation management, water meter reading data may be entered into the application in a variety of ways and through any computing device with an Internet connection. For example, water meter data may be entered manually by a user with access to the application. Or, water meter data may be entered into the application via structured text message or e-mail which is sent directly to the application with sufficient information for the application to properly associate text messaged data with the proper application instance, the proper project within the proper application instance, and the proper meter ID, metering reading date, and meter reading value associated with the proper project and application instance. In a third embodiment, water meter data may be entered into the application via a photograph of the water meter details including the meter reading, said photograph having been taken with the mobile computing device through which the structured text message or e-mail will be sent. The attached photograph of the meter and the meter's reading will have the necessary geo-positioning data embedded within the photograph data which would allow the application to automatically determine which meter the meter reading data is associated with. Furthermore, the application may employ character recognition techniques that would allow the application to deduce the meter reading value from the photograph and thus save time and reduce errors associated with manual meter reading data collection and transmittal. In yet another embodiment, data entry may be performed automatically when the application is permitted to interface with a water retailer's or water district's billing system software whereby historical water meter usage and water meter cost data may be queried and accessed directly by the application software so that historical water meter usage and water meter cost data may be automatically uploaded into the application software, In still yet another embodiment, the irrigation billing cycle budget calculation engine with predictive irrigation system adjustment index calculation capability may be extracted from the application software and embedded in irrigation controllers for the purpose of controlling and regulating irrigation system output based on the local, prevailing water retailer's water billing rules and water budget rules which may change from time to time for a number of reasons including but not limited to the water retailer's imposing of an irrigation standard to which landscape plant materials must comply, as has been previously described.

While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system, comprising:
one or more servers implementing an irrigation billing cycle budget calculation engine that includes a water district database storing water billing rules and water budget rules for a project, a evapotranspiration database storing weather data and evapotranspiration data (ETo) for the project, and a project database storing landscape area, water meter descriptions and water usage data of the project wherein the irrigation billing cycle budget calculation engine:
determines the irrigation budget based on the water billing rules, water budget rules, evapotranspiration data, evapotranspiration adjustment factor, and landscape area;
provides the irrigation budget to user computing device to be presented to a user computing device;
provides actual water usage compared to irrigation budget to user computing device to be presented to the user

2. The system of claim 1, wherein the irrigation billing cycle budget calculation engine updates the water billing rules and the water budget rules stored in the water district database by accessing water rates and water rate structures from one or more public water district databases.

3. The system of claim 1, wherein the irrigation billing cycle budget calculation engine updates the ETo data by accessing historical ETo data, historical weather data, current ETo data, and current weather data from public and private sources of ETo and weather data.

4. The system of claim 1, wherein the irrigation billing cycle budget calculation engine receives input project information from the user computing device and stores such input project information in the project database.

5. The system of claim 1, wherein the input project information includes project address, project water district, landscape area, project meter zones, project meter data, project map, project water billing information including project water billing cycle, water retailer, and water billing period.

6. The system of claim 5, wherein the irrigation billing cycle budget calculation engine receives one or more map edit instructions from the user computing device and edits the project map based on the map edit instructions.

7. The system of claim 5, wherein the irrigation billing cycle budget calculation engine receives meter zone information from the user computing device and edits the project map based on the meter zone information.

8. The system of claim 1, wherein the irrigation billing cycle budget calculation engine provides dashboard information to the user computing device that includes at least one of meter alert status, meters within budget, actual usage compared to water budget, project water usage statistics, landscape asset inventory, and landscape asset value.

9. The system of claim 1, wherein the irrigation billing cycle budget calculation engine calculates and provides meter usage data, water budget associated with a meter zone, total cost for irrigation associated with a meter zone, over budget cost associated with a meter zone, and an adjustment calculation associated with a meter zone.

10. The system of claim 1, wherein the irrigation billing cycle budget calculation engine receives meter data through at least one of an user interface of an application on the user computing device; a text message, e-mail message, a photograph, and an interface with a meter data database.

11. The system of claim 1, wherein the irrigation billing cycle budget calculation engine provides map data and meter data including geographic positioning data of a meter to the user computing device to display a project map that includes meter icons positioned on the project map based on the geographic positioning data of the meter.

12. The system of claim 1, wherein the irrigation billing cycle budget calculation engine provides map data and geographic positional data of plant material for a meter zone to the user computing device to display a project map that includes plant material icons positioned on the project map based on the geographic positional data of plant material for a meter zone.

13. The system of claim 1, wherein the irrigation billing cycle budget calculation engine:
receives work order information and a project map for a project;
determining work order map information based on the work order information and the project map;
provides map data, work order information, and work order map information to the user computing device such that the work order information is displayed on the project map based on the work order map information.

14. A device, comprising:
one or more processors implementing an irrigation billing cycle budget calculation engine that includes a water district database storing water billing rules and water budget rules for a project, a evapotranspiration database storing weather data and evapotranspiration data (ETo) for the project, and a project database storing landscape area, water meter descriptions and water usage data of the project wherein the irrigation billing cycle budget calculation engine:
determines the irrigation budget based on the water billing rules, water budget rules, evapotranspiration data, evapotranspiration adjustment factor, and landscape area;
provides the irrigation budget to user computing device to be presented to a user;
provides actual water usage compared to irrigation budget to the user computing device to be presented to the user.

15. The device of claim 14, wherein the irrigation billing cycle budget calculation engine updates the water billing rules and the water budget rules stored in the water district database by accessing water rates and water rate structures from one or more public water district databases.

16. The device of claim 14, wherein the irrigation billing cycle budget calculation engine updates the ETo data by accessing historical ETo data, historical weather data, current ETo data, and current weather data, from public and private sources of ETo and weather data.

17. The device of claim 14, wherein the irrigation billing cycle budget calculation engine receives input project information from the user computing device and stores such input project information in the project database.

18. The device of claim 14, wherein the input project information includes project address, project water district, landscape area, project meter zones, project meter data, project map, project water billing information including project water billing cycle, water retailer, and water billing period.

19. The device of claim 18, wherein the irrigation billing cycle budget calculation engine receives one or more map edit instructions from the user computing device and edits the project map based on the map edit instructions.

20. The device of claim 18, wherein the irrigation billing cycle budget calculation engine receives meter zone information from the user computing device and edits the project map based on the meter zone information.

21. The device of claim 14, wherein the irrigation billing cycle budget calculation engine provides dashboard information to the user computing device that includes at least one of meter alert status, meters within budget, actual usage compared to water budget, project water usage statistics, plant material, and landscape asset value.

22. The device of claim 14, wherein the irrigation billing cycle budget calculation engine calculates and provides meter usage data, water budget associated with a meter zone, total cost for irrigation associated with a meter zone, over budget cost associated with a meter zone, and an adjustment calculation associated with a meter zone.

23. The device of claim 14, wherein the irrigation billing cycle budget calculation engine receives meter data through at least one of an user interface of an application on the user computing device; a text message, e-mail message, a photograph, and an interface with a meter data database.

24. The device of claim 14, wherein the irrigation billing cycle budget calculation engine provides map data and meter data including geographic positioning data of a meter to the user computing device to display a project map that includes meter icons positioned on the project map based on the geographic positioning data of the meter.

25. The device of claim 14, wherein the irrigation billing cycle budget calculation engine provides map data and geographic positional data of plant material for a meter zone to the user computing device to display a project map that includes plant material icons positioned on the project map based on the geographic positional data of plant material for a meter zone.

26. The device of claim 14, wherein the irrigation billing cycle budget calculation engine:
receives work order information and a project map for a project;
determining work order map information based on the work order information and the project map;
provides map data, work order information, and work order map information to the user computing device such that the work order information is displayed on the project map based on the work order map information.

27. A method, comprising:
determining, by an irrigation billing cycle budget calculation engine, an irrigation budget based on the water billing rules, water budget rules, evapotranspiration data, evapotranspiration adjustment factor, and landscape area wherein the irrigation billing cycle budget calculation engine that includes a water district database storing water billing rules and water budget rules for a project, a evapotranspiration database storing weather data and evapotranspiration data (ETo) for the project, and a project database storing landscape area, water meter descriptions and water usage data of the project wherein the irrigation billing cycle budget calculation engine;
providing the irrigation budget to user computing device to be presented to a user;
providing actual water usage compared to irrigation budget to user computing device to be presented to the user.

28. The method of claim 27, further comprising updating, by an irrigation billing cycle budget calculation engine, the water billing rules and the water budget rules stored in the water district database by accessing water rates and water rate structures from one or more public water district databases.

29. The method of claim 27, further comprising updating, by an irrigation billing cycle budget calculation engine, the ETo data by accessing historical ETo data, historical weather data, current ETo data, and current weather data, from public and private sources of ETo and weather data.

30. The method of claim 27, further comprising receiving, by an irrigation billing cycle budget calculation engine, input project information from the user computing device and stores such input project information in the project database.

31. The method of claim 27, wherein the input project information includes project address, project water district, landscape area, project meter zones, project meter data, project map project water billing information including project water billing cycle, and water retailer, water billing period.

32. The method of claim 31, further comprising receiving, by an irrigation billing cycle budget calculation engine, one or more map edit instructions from the user computing device and edits the project map based on the map edit instructions.

33. The method of claim 31, further comprising receiving, by an irrigation billing cycle budget calculation engine, meter zone information from the user computing device and edits the project map based on the meter zone information.

34. The method of claim 27, further comprising providing, by an irrigation billing cycle budget calculation engine, dashboard information to the user computing device that includes at least one of meter alert status, meters within budget, actual usage compared to water budget, project water usage statistics, plant material inventory, and landscape asset value.

35. The method of claim 27, further comprising calculating and providing, by an irrigation billing cycle budget calculation engine, meter usage data, water budget associated with a meter zone, total cost for irrigation associated with a meter zone, over budget cost associated with a meter zone, and an adjustment calculate associated with a meter zone.

36. The method of claim 27, further comprising receiving, by an irrigation billing cycle budget calculation engine, meter data through at least one of an user interface of an application on the user computing device; a text message, e-mail message, a photograph, and an interface with a meter data database.

37. The method of claim 27, further comprising providing, by an irrigation billing cycle budget calculation engine, map data and meter data including geographic positioning data of a meter to the user computing device to display a project map that includes meter icons positioned on the project map based on the geographic positioning data of the meter.

38. The method of claim 27, further comprising providing, by an irrigation billing cycle budget calculation engine, map data and geographic positional data of plant material for a meter zone to the user computing device to display a project map that includes plant material icons positioned on the project map based on the geographic positional data of plant material for a meter zone.

39. The method of claim 27, further comprising:
receiving, by an irrigation billing cycle budget calculation engine, work order information and a project map for a project;
determining, by an irrigation billing cycle budget calculation engine, work order map information based on the work order information and the project map;
providing, by an irrigation billing cycle budget calculation engine, map data, work order information, and work order map information to the user computing device such that the work order information is displayed on the project map based on the work order map information.
